(19) United States
(12) Patent Application Publication
(10) Pub. No.: US 2015/0061835 A1
(43) Pub. Date: Mar. 5, 2015

(54) WIRELESS TAG COMMUNICATION DEVICE, WIRELESS TAG COMMUNICATION SYSTEM AND PROGRAM

(71) Applicant: Toshiba Tec Kabushiki Kaisha, Tokyo (JP)

(72) Inventors: KOUICHI SANO, Shizuoka-ken (JP); Jun Yaginuma, Shizuoka-ken (JP); Sunao Tsuchida, Shizuoka-ken (JP)

(73) Assignee: Toshiba Tec Kabushiki Kaisha, Tokyo (JP)

(21) Appl. No.: 14/017,008

(22) Filed: Sep. 3, 2013

(30) Foreign Application Priority Data
Sep. 3, 2013 (JP) 2012-193042

(51) Int. Cl. G06K 7/00; G06Q 10/08; G06K 7/10

(52) U.S. Cl. CPC G06K 7/0008; G06K 7/10386; G06K 7/10217; G06Q 10/087; G06K 2007/10524
USPC 340/10.3

(57) ABSTRACT

A wireless tag communication device which communicates with wireless tags storing identification information, includes a wireless tag communication unit that performs a reading of wireless tags by a first read function that does not designate the wireless tags and a second read function that designates the wireless tags, a comparison unit that compares information of the wireless tags that are stored in a storage unit with read information of the wireless tags and outputs a read result, a route information setting unit that sets designation order values of wireless tags present in a list of read objects but not read by the first read function, when the wireless tags are designated and read by the second read function, and an unread list generation unit that generates an unread list using at least a result read by the second read function.

### CROSS-REFERENCE TO RELATED APPLICATION

This application is based upon and claims the benefit of priority from Japanese Patent Application No. 2012-193042, filed Sep. 3, 2012, the entire contents of which are incorporated herein by reference.

### FIELD

Exemplary embodiments described herein generally relate to a wireless tag communication device, a wireless tag communication system, and a program which aim to provide an efficient inventory system.

### BACKGROUND

Generally, an inventory system is used in which wireless tags with identification information stored therein are attached to products and goods in stores, warehouses, or the like, and information on the wireless tags are read by a wireless tag communication device, and the read information is compared with list information (hereinafter, referred to as an inventory list) of products and goods. Since the inventory system can read a plurality of wireless tags in a short time using radio wave and efficiently perform inventory work, it is attracting attention.

In an inventory work incorporating wireless tags, it is common for an operator to attempt to read all wireless tags attached to products and goods using a portable wireless tag communication device, while moving through an entire area where the products and goods objects are present. After the operator performs reading work in the entire area, when there is a difference between read information and an inventory list, the operator searches for and visually confirms the products corresponding to the difference one by one.

The inventory list and the read information may be different in two cases, including the case where wireless tags present in the inventory list are not read, or the case where wireless tags not present in the inventory list are read. The first reason as to why the wireless tags present in the inventory list are not read is as follows. The wireless tags may be located in the shadow of products or in a barrier between products, so signals transmitted from a wireless tag communication device are attenuated prior to reaching the wireless tags, or response signals from the wireless tags are attenuated prior to reaching the wireless tag communication device.

The second reason as to why the wireless tags present in the inventory list are not read is as follows. A reading may be carried out while the wireless tag communication device is being moved. Therefore, when the wireless tag communication device is moved as the wireless tag communication device and wireless tags communicate, if the distance from the reader to the wireless tags deviates from a readable range before communication with the wireless tag communication device is completed, a communication error is generated.

JP-A-2009-88779 discloses a wireless tag communication device. The wireless tag communication device designates one wireless tag being a read object and attempts reading over and over again, and thus a possibility of reading the wireless tag is increased even when signals have been attenuated.

However, when the wireless tag is designated as the read object and read, if a plurality of unread wireless tags are present, it is necessary to set order values of wireless tags from which readings will be attempted. In a state where the wireless tags corresponding to the order values are randomly distributed and arranged in a store, the operator should move back and forth to a same place in the store many times. Therefore, it is time consuming and inefficient to establish correspondence of the tags to inventory using this system.

Further, when wireless tags which are not present in the inventory list have been read, after the read operation has been completed over an entire area, the operator has to search for and visually specify the corresponding products one by one, and this is time consuming and inefficient.

### DESCRIPTION OF THE DRAWINGS

FIG. 1 is an explanatory diagram of inventory work using a wireless tag communication device according to an embodiment.

FIGS. 2A to 2C are external views of the wireless tag communication device according to an embodiment.

FIG. 3 is a block diagram illustrating a main configuration of the wireless tag communication device according to an embodiment.

FIG. 4 is a block diagram illustrating a specific configuration of a wireless tag communication unit and a communication controller according to an embodiment.

FIG. 5A is a flow chart illustrating a processing procedure of a controller in an embodiment.

FIG. 5B is a flow chart illustrating a processing procedure of the controller following FIG. 5A.

FIG. 6 is an explanatory diagram illustrating an example of an inventory list according to an embodiment.

FIG. 7 is a timing chart of a first example of a wireless communication protocol in an embodiment.

FIG. 8 is an explanatory diagram illustrating an example of tag read information in an embodiment.

FIG. 9 is an explanatory diagram illustrating another example of an inventory list in an embodiment.

FIG. 10 is an explanatory diagram illustrating an example of a display screen at the time of setting route information in an embodiment.

FIG. 11 is an explanatory diagram illustrating an example of an unread list in an embodiment.

FIG. 12 is a timing chart of a second example of a wireless communication protocol in an embodiment.

FIG. 13A is a flow chart illustrating a processing procedure of a controller according to a second embodiment.

FIG. 13B is a flow chart illustrating a processing procedure of the controller following FIG. 13A.

FIG. 14 is an explanatory diagram illustrating an example of tag read information in the second embodiment.

FIG. 15 is an explanatory diagram illustrating a route generation example in the second embodiment.

FIG. 16A is a flow chart illustrating a processing procedure of a controller in a third embodiment.

FIG. 16B is a flow chart illustrating a processing procedure of a controller following FIG. 16A.

FIG. 17 is a timing chart of a wireless communication protocol in a third embodiment.

FIG. 18 is a block diagram illustrating a configuration of a wireless tag communication system according to a fourth embodiment.

FIG. 19A is a flow chart illustrating a processing procedure of a controller and a host device in the fourth embodiment.

FIG. 19B is a flow chart illustrating a processing procedure of the controller and the host device following FIG. 19A.

FIG. 20A is a flow chart illustrating a processing procedure of a controller and a host device in a fifth embodiment.

FIG. 20B is a flow chart illustrating a processing procedure of the controller following FIG. 20A.

### DETAILED DESCRIPTION

According to an embodiment, there is provided a wireless tag communication device, a wireless tag communication system and a program which can improve a read rate of wireless tags and efficiently perform inventory work in a short time.

In general, according to one embodiment, a wireless tag communication device is provided which communicates with wireless tags that are attached to a plurality of goods and stores at least tag identification information, and reads information stored in the wireless tags. The device includes a wireless tag communication unit which communicates with the wireless tags by a first read function that does not designate the wireless tags and a second read function that designates the wireless tags, a controller that controls the wireless tag communication unit, a storage unit that stores information of wireless tags as read objects, a comparison unit which compares information of the wireless tags stored in the storage unit with read information of the wireless tags that have been read in the wireless tag communication unit, and outputs a read result, a route information setting unit that sets designation order values of wireless tags present in a list of the read objects but not being read by the first read function, when the wireless tags are designated and read by the second read function, and an unread list generation unit that generates an unread list, on a basis of information of the designated wireless tags, a result read by the second read function, and information of the designation order values that are set in the route information setting unit.

Hereinafter, exemplary embodiments will be described with reference to the drawings. In addition, the same reference numerals are given to the same parts in each drawing.

### First Embodiment

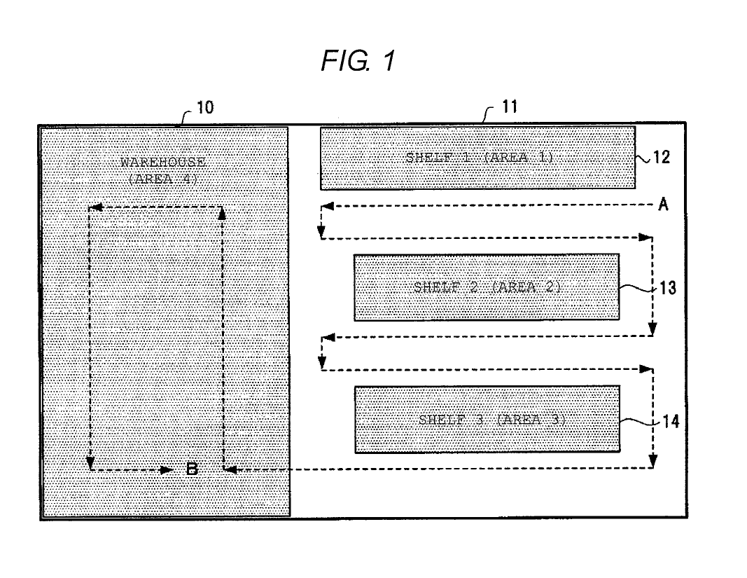

FIG. 1 is an explanatory diagram of performing an inventory using a wireless tag communication device according to an embodiment. In an example of FIG. 1, a warehouse 10 and a store 11 are located adjacent to each other, selves 12, 13 and 14 are disposed in the store 11, and products such as goods are placed in each of the shelves 12, 13 and 14 and the warehouse 10. A wireless tag (described later) is attached to each of goods (products).

When an operator performs inventory work, the operator moves along a route indicated by a broken line, for example, from a point A of FIG. 1 while carrying the wireless tag communication device, and thereby reads wireless tags of products in a shelf 1 (area 1), a shelf 2 (area 2) and a shelf 3 (area 3). Next, the operator moves through the warehouse area 4 and thereby reads wireless tags of the products in the warehouse 10 (area 4) and moves to a point B.

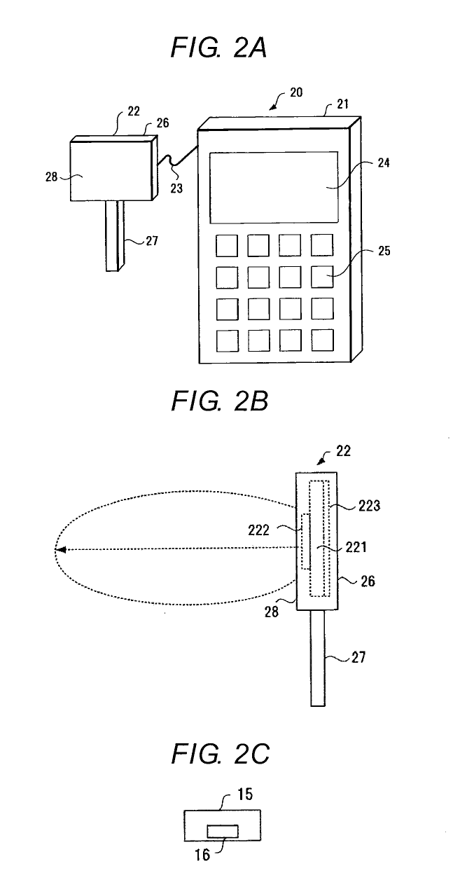

FIG. 2A is an external view of the wireless tag communication device 20. The wireless tag communication device 20 includes a main body 21 and an antenna 22. The main body 21 and the antenna 22 are connected by a cable 23, and both of them are portable. The main body 21 includes a notification unit 24 such as a display, and an input unit 25 such as a keyboard.

In the antenna 22, a grip 27 is attached to a plate-like antenna housing 26. The operator performs a reading of wireless tags by directing an antenna face 28 of the antenna 22 in certain direction while holding the grip 27. In addition, it is illustrated in FIG. 2 that the main body 21 and the antenna 22 are separate devices, but the main body 21 and the antenna 22 may be configured to be integrated.

As shown in FIG. 2B, the antenna 22 is a planar patch antenna in which a plate-like dielectric 221 is fixed to inside the antenna housing 26, a radiator 222 is provided on the antenna face 28 side of the dielectric 221, and a ground 223 is provided on an opposite rear side. Then, the antenna 22 has directivity with a maximum gain in a substantially vertical direction from a center of the antenna face 28.

FIG. 2C illustrates a wireless tag 15 that is attached to products. The wireless tag 15 has a storage unit 16 which stores identification information (tag ID), and the like. The wireless tag communication device 20 reads tag ID and the like stored in the wireless tag 15 of each of products. In the below description, a reading of the information stored in the wireless tag 15 is represented as “a reading of a wireless tag 15” for convenience of explanation.

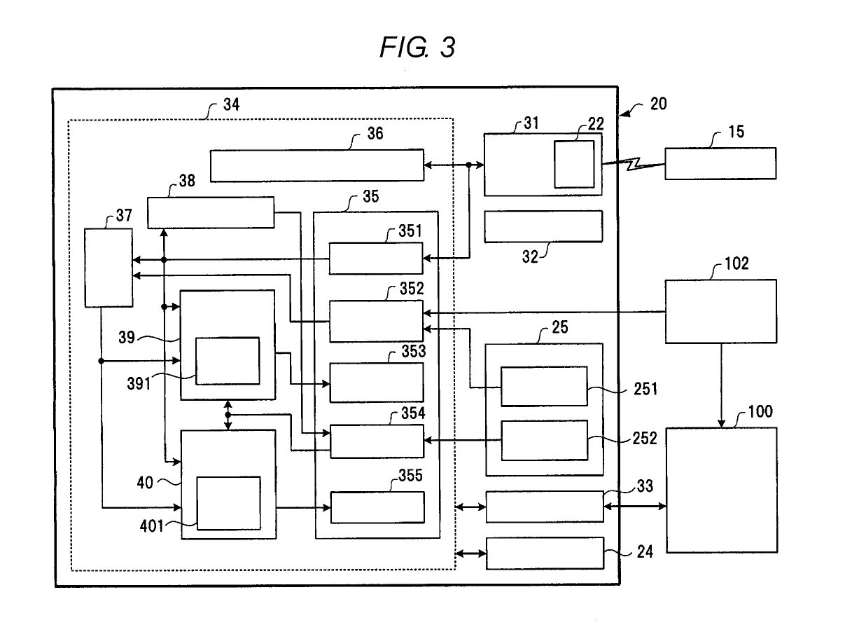

FIG. 3 is a block diagram illustrating a configuration of the wireless tag communication device 20. The wireless tag communication device 20 (hereinafter, simply referred to as a communication device 20) includes a wireless tag communication unit 31, a power supply unit 32, a communication unit 33 that communicates with a host device 100, and a controller 34, in addition to the notification unit 24 and the input unit 25.

The wireless tag communication unit 31 includes an antenna 22, and wirelessly communicates with the wireless tag 15 to receive and read the identification information (tag ID) and the like stored in the storage unit 16 of the wireless tag 15. The detailed description of the wireless tag communication unit 31 will be given later.

The power supply unit 32 includes a battery and a control circuit that charges and discharges the battery. The notification unit 24 includes a display and a buzzer. The input unit 25 is a keyboard. In addition, the input unit 25 may be a touch panel that is installed on the display of the notification unit 24. The communication unit 33 for communication with the host device 100 (for example, server) performs a communication with the host device 100 connected through a communication line. The communication line may be configured in a wired manner or wireless manner.

The host device 100 stores product information corresponding to the identification information of the wireless tag 15, and the communication device 20 can communicate with the host device 100 through the communication unit 33. A product area information input unit 101 inputs area information, a portion of product information, stored in a storage unit 35 (described later) of the communication device 20 or the host device 100. The product area information input unit 101 performs an input when an area (position) in which products are placed, is changed, or the like.

The controller 34 constitutes a computer, includes a Central Processing Unit (CPU), and controls the input unit 25, the notification unit 24, the wireless tag communication unit 31, the power supply unit 32 and the communication unit 33 so as to control the whole communication device 20. The controller 34 includes a storage unit 35 configured by a Read Only Memory (ROM) and a Random Access Memory (RAM). The ROM stores in advance a program used by the controller 34, setting data, and the like. Variable data is temporarily written to the RAM by the action of the controller 34.

Further, the RAM stores tag read information 351 including the identification information of the wireless tags received by the wireless tag communication unit 31, information (the inventory list) 352 regarding the wireless tags attached to products that are read objects and should be located in the store, an unread list 353 that is information of wireless tags present in the inventory list 352, but not present in the tag read information 351, route information 354 that is set by input of the input unit 25, and a search list 355 that is information of wireless tags that are received in the wireless tag communication unit 31, but are not present in the inventory list 352.

An inventory list setting unit 251 of the input unit 25 selects whether to obtain the inventory list 352 through the host device 100 through the communication unit 33 or to use the inventory list 352 stored in advance in the storage unit 35. Further, the content selected by the route information setting unit 252 of the input unit 25 is set in the route information 354.

The controller 34 includes a communication controller 36. The communication controller 36 performs control of setting of a transmission output and transmission data in the wireless tag communication unit 31, and controls received data. The communication controller 36 will be described later together with the wireless tag communication unit 31.

Further, the controller 34 includes a comparison unit 37, a route information generation unit 38, an unread list generation unit 39 and a search list generation unit 40. The comparison unit 37 compares the tag read information 351 with the inventory list 352 to output a read result. The route information generation unit 38 generates route information from the tag read information 351. The unread list generation unit 39 includes a designation order information generation unit 391, and generates an unread list 353 including the designation order information on a basis of tag read information 351, the comparison result of the comparison unit 37, and the route information 354.

The search list generation unit 40 includes a designation order information generation unit 401, and generates a search list including the designation order information on a basis of tag read information 351, the comparison result of the comparison unit 37, and the route information 354. The detailed description of the comparison unit 37, the route information generation unit 38, the unread list generation unit 39, and the search list generation unit 40 will be given later.

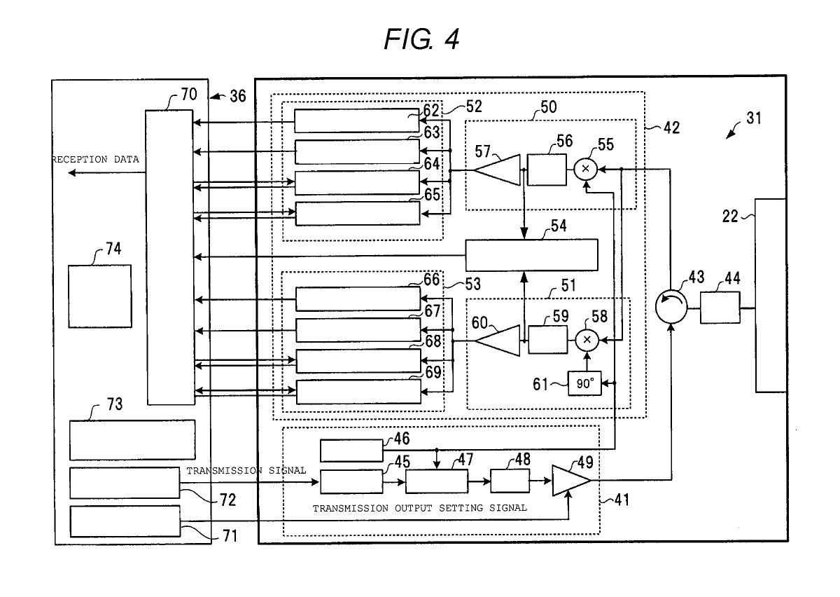

FIG. 4 is a block diagram illustrating a specific configuration of the wireless tag communication unit 31 and the communication controller 36. The wireless tag communication unit 31 includes a transmission unit 41 that transmits data to the wireless tag 15, a reception unit 42 that receives data from the wireless tag 15, a directional coupler 43 such as a circulator, a low pass filter 44, and the antenna 22. The transmission unit 41, the reception unit 42 and the low pass filter 44 are connected to the directional coupler 43, and the directional coupler 43 is connected to the antenna 22 through the low pass filter 44.

The transmission unit 41 includes a coding unit 45, a Phase Locked Loop (PLL) unit 46, an amplitude modulation unit 47, a band pass filter 48 and a power amplifier 49. The coding unit 45 codes a transmission signal that is output from a transmission controller 72 of the communication controller 36. The PLL unit 46 supplies the amplitude modulation unit 47 with a local carrier signal. The amplitude modulation unit 47 modulates the amplitude of the local carrier signal from the PLL unit 46 with the transmission signal that is coded in the coding unit 45. The band pass filter 48 eliminates unnecessary components from the transmission signal that is amplitude-modulated in the amplitude modulation unit 47. The power amplifier 49 amplifies the transmission signal by an amplification factor corresponding to a transmission output setting signal from the transmission output setting unit 71 of the communication controller 36. The transmission output is changed by amplifying the transmission signal, and the transmission signal amplified in the power amplifier 49 is supplied to the directional coupler 43.

The directional coupler 43 supplies the transmission signal from the transmission unit 41 to the antenna 22 through the low pass filter 44. The transmission signal supplied to the antenna 22 is radiated as a radio wave from the antenna 22. The wireless tag 15 is activated by receiving the radio wave radiated from the antenna 22. The activated wireless tag 15 performs a backscatter modulation on an unmodulated signal and wirelessly transmits information stored in the storage unit 16 of the wireless tag 15 to the communication device 20. The wireless signal from the wireless tag 15 is received by the antenna 22.

The reception signal received by the antenna 22 is supplied to the directional coupler 43 through the low pass filter 44. The directional coupler 43 supplies the reception signal of the antenna 22, that is, the signal from the wireless tag 15, to the reception unit 42. The reception unit 42 includes an I signal generation unit 50, a Q signal generation unit 51, an I signal processing unit 52, a Q signal processing unit 53 and a reception signal level detection unit 54.

The I signal generation unit 50 is configured by a mixer 55, a low pass filter 56, and a binarization circuit 57. The Q signal generation unit 51 is configured by a mixer 58, a low pass filter 59, a binarization circuit 60, and a 90 degree phase shifter 61.

The I signal processing unit 52 is configured by an I signal synchronous clock generation unit 62, an I signal preamble detection unit 63, an I signal decoding unit 64, and an I signal error detection unit 65. The Q signal processing unit 53 is configured of a Q signal synchronous clock generation unit 66, a Q signal preamble detection unit 67, a Q signal decoding unit 68, and a Q signal error detection unit 69.

The reception unit 42 respectively inputs a reception signal from the directional coupler 43 to the first mixer 55 and the second mixer 58. Further, the reception unit 42 inputs a local carrier signal from the PLL unit 46 to the first mixer 55 and the 90 degree phase shifter 61. The 90 degree phase shifter 61 shifts the phase of the local carrier signal by 90 degrees and supplies the shifted signal to the second mixer 58.

The first mixer 55 mixes the reception signal and the local carrier signal to generate an I signal that is an in-phase component of the local carrier signal. The I signal is supplied to the binarization circuit 57 through the low pass filter 56. The low pass filter 56 eliminates an unnecessary high-frequency component from the I signal to extract a coded data component. The binarization circuit 57 binarizes a signal passing through the low pass filter 56.

The second mixer 58 mixes the reception signal and the local carrier signal of which a phase is shifted by 90 degrees to generate a Q signal of a component in quadrature with the local carrier signal. The Q signal is supplied to the binarization circuit 60 through the low pass filter 59. The low pass filter 59 eliminates an unnecessary high-frequency component from the Q signal to extract a coded data component. The binarization circuit 60 binarizes a signal passing through the low pass filter 59.

The I signal that is binarized in the binarization circuit 57 is supplied to each of units 62 to 65 of I signal processing unit 52. The Q signal that is binarized in the binarization circuit 60 is supplied to each of units 66 to 69 of the Q signal processing unit 53. Since the I signal processing unit 52 and the Q signal processing unit 53 are common in their operations, the I signal processing unit 52 will be described hereinafter, and the description of the Q signal processing unit 53 will not be given.

The synchronous clock generation unit 62 normally generates a clock signal synchronized with the binary signal from the binarization circuit 57, and supplies the generated clock signal to the reception controller 70 of the communication controller 36, the preamble detection unit 63, the decoding unit 64 and the error detection unit 65.

The preamble detection unit 63 detects a preamble attached to the beginning of the I signal, on a basis of the clock signal from the synchronous clock generation unit 62. If the preamble is detected, the preamble detection unit 63 outputs the detection signal to the reception controller 70 of the communication controller 36. If the preamble detection signal is received, the reception controller 70 supplies a command signal to start a decoding to the decoding unit 64. The decoding unit 64 samples the binary signal from the binarization circuit 57 in synchronization with the clock signal from the synchronous clock generation unit 62. Then, the decoding unit 64 decodes the sampled binary signal, if receiving the command to start a decoding from the reception controller 70. The decoded data is supplied to the reception controller 70.

The reception controller 70 supplies the decoded data to the error detection unit 65. The error detection unit 65 detects the presence or absence of an error from a check code of the decoded data. Then, the error detection unit 65 supplies the reception controller 70 with data indicating a detection result. When there is no error in at least one of the I signal or the Q signal, the reception controller 70 determines that data is correctly received. The correctly received data is stored as tag read information 351 in the storage unit 35.

The reception signal level detection unit 54 respectively detects the amplitude of the I signal passed through the low pass filter 56 and the Q signal passed through the low pass filter 59. Then, a larger amplitude value is notified to the communication controller 36 as the reception signal level. Alternatively, a value (√{I²+Q²}) that is a value obtained by vector synthesizing the I signal and Q signal may be notified as the reception signal level.

The communication controller 36 includes a transmission output setting unit 71, a transmission controller 72, a function setting unit 73 and a reception state detection unit 74, in addition to the reception controller 70. The reception state detection unit 74 calculates a reception success rate (Equation 1 below) during a predetermined time. Alternatively, the reception state may be detected using an average value or a maximum value of the reception signal level that is notified from the reception signal level detection unit 54 during a predetermined time.

Reception success rate=number of times when data has been received correctly/(number of times when data has been received correctly+number of times when an error has been detected) (Equation 1)

Hereinafter, a read operation of the wireless tag 15 using the protocol of ISO 18000-6C will be described. The communication device 20 has three read functions including a normal read function (first read function) using the protocol of ISO 18000-6C, a designation read function (second read function), and a designation read repeat function (third read function). The function setting unit 73 sets one of the normal read function, the designation read function, and the designation read repeat function. The transmission controller 72, the transmission output setting unit 71, and the reception state detection unit 74 perform operations corresponding to a function that is set in the function setting unit 73.

The normal read function is a function of performing a reading without designating the wireless tag 15. The normal read function communicates with the wireless tag 15 that is activated by receiving the radio wave radiated from the antenna 22 and is in a communicable state, and reads the identification information stored in the storage unit 16 of the wireless tag 15.

The designation read function is a function of performing a reading by designating a tag that responds to Select command of ISO 18000-6C. The wireless tags 15 are activated by receiving the radio wave radiated from the antenna 22, but only a wireless tag 15 which matches the identification information designated in the Select command responds. The designation read function communicates with the wireless tag 15 and reads the identification information stored in the storage unit 16.

Similar to the designation read function, the designation read repeat function is a function of designating a tag that responds to Select command of ISO 18000-6 type C and repeatedly performing a read, and in addition thereto, the designation read repeat function notifies a reception state detected in the reception state detection unit 74 by the notification unit 24. Further, the designation read repeat function assists in specifying the wireless tag 15 designated by the operator by setting a transmission output setting signal in the transmission output setting unit 71 depending on the reception state detected in the reception state detection unit 74 to control the transmission output and by narrowing the possible location range of the designated wireless tag 15.

Hereinafter, three read functions including the normal read function, the designation read function, and the designation read repeat function used in performing an inventory will be described.

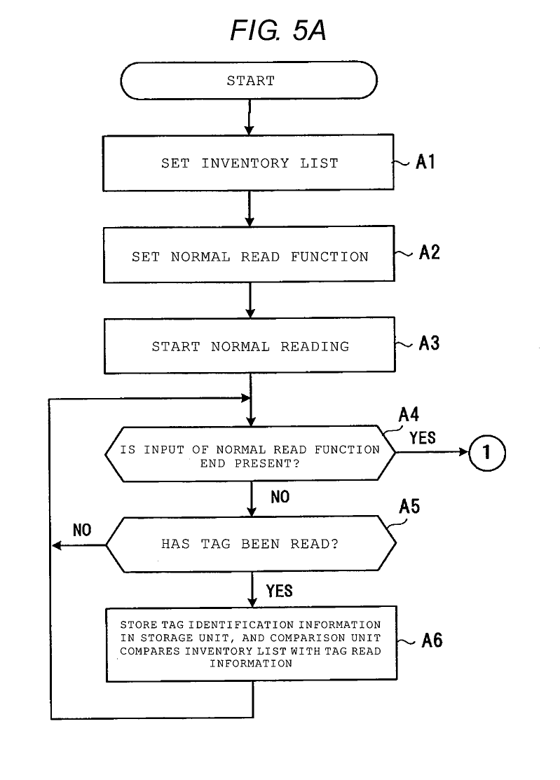

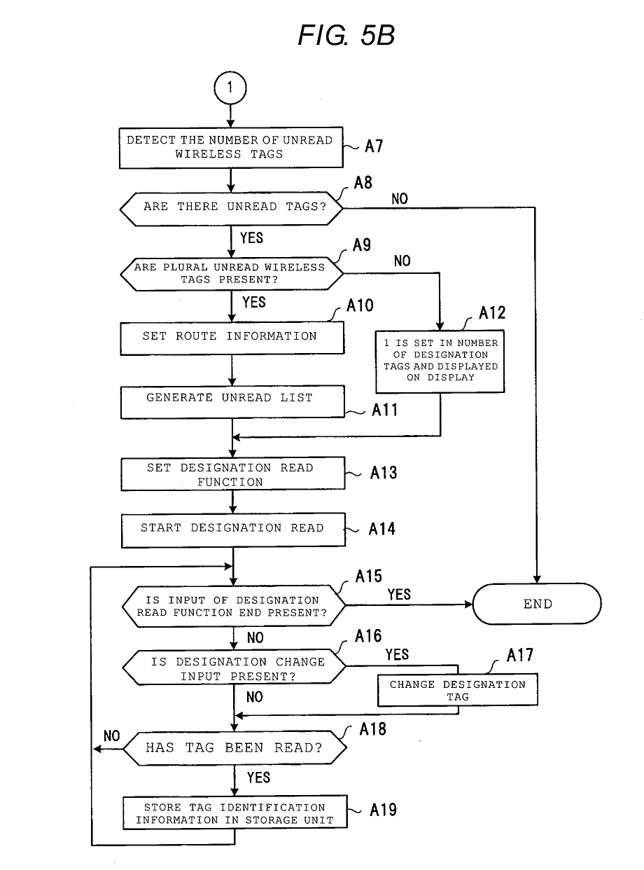

FIGS. 5A and 5B are flow charts illustrating the processing procedure of the controller 34 in a case of performing inventory work using the communication device 20. The procedure is controlled by an inventory program stored in the ROM of the storage unit 35.

If the operator carries the communication device 20 and operates, for example, an inventory start key of the input unit 25 at a point A of FIG. 1, the inventory program is activated. First, the controller 34 sets the inventory list 352 (Act A1). Although not being illustrated, the display 24 displays a screen regarding whether to use the inventory list that is stored in advance in the inventory list 352 of the storage unit 35, or to receive the inventory list from the host device 100 through the communication unit 33 and to store the received inventory list in the inventory list 352 of the storage unit 35. Then, the inventory list 352 is set according to a manner that is input and selected by the operator using the input unit 25. When the latter is selected, the inventory list 352 is set by receiving the inventory list from the host device 100 through the communication unit 33 and storing the received inventory list in the storage unit 35.

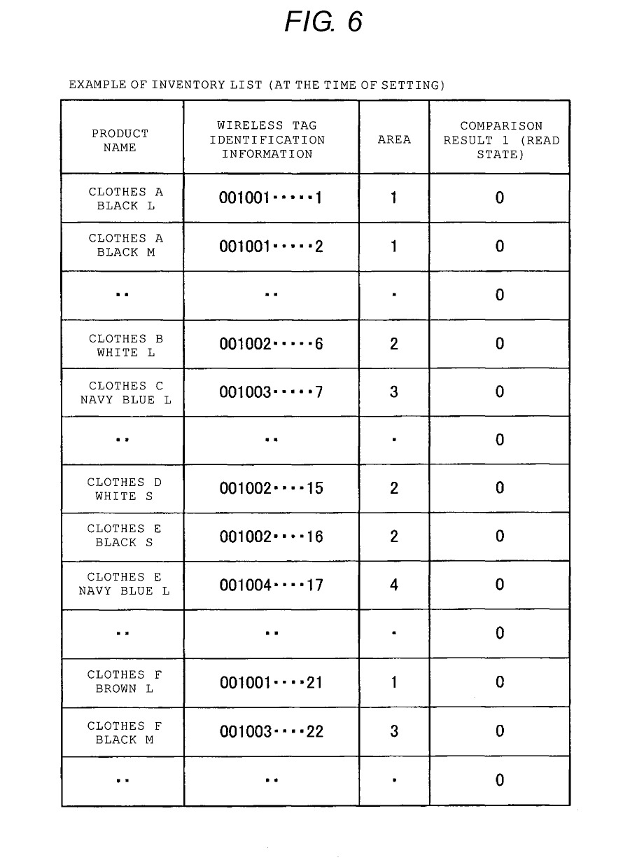

FIG. 6 is an example of the inventory list 352 at the time of setting. In the example of FIG. 6, the inventory list is configured by a product name, identification information of a wireless tag that is attached to a product, an area number where the product should be placed, and a comparison result 1 of the comparison unit 37. Zeros are stored for all the comparison results 1 at the time of setting prior to performing a reading by the normal read function. The comparison unit 37 changes the content of the comparison result 1 to “1” in a case of detecting that tag identification information read by the normal read function is in the inventory list 352.

Next, the controller 34 sets the normal read function in the function setting unit 73 of the communication controller 36 (Act A2). At Act A2, a transmission output setting signal corresponding to a transmission output of the normal read function that is set in advance is output from the transmission output setting unit 71. Further, a transmission signal of the normal read function is output from the transmission controller 72, and the transmission controller 72 sets a timing of transmission, and the like.

Next, normal reading is started (Act A3). When the transmission output setting unit 71 outputs the transmission output setting signal, an unmodulated carrier signal is radiated as a radio wave from the antenna 22. When the transmission controller 72 outputs the transmission signal, a transmission to the wireless tag 15 is performed. The controller 34 determines whether there is a key input of the normal read function end from the input unit 25 (Act A4), and the normal reading continues until the key input of the normal read function end is detected.

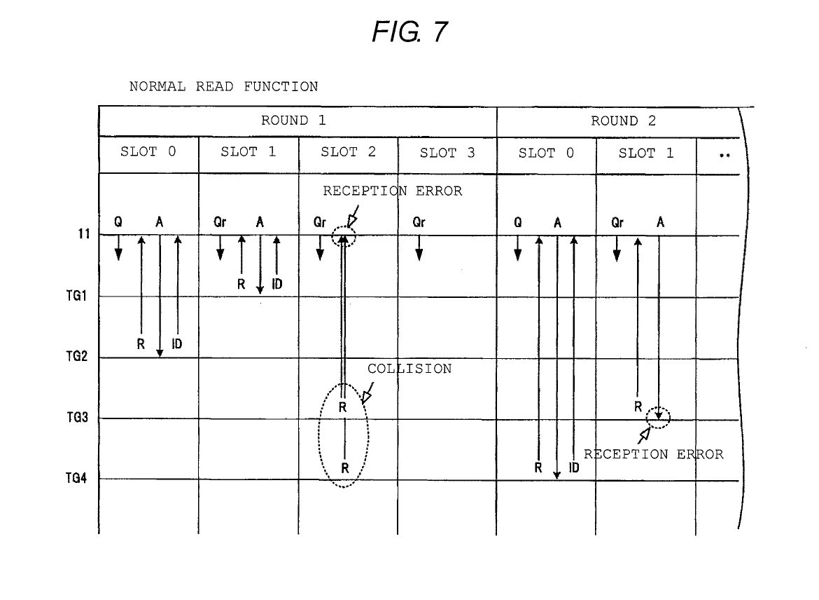

FIG. 7 is a timing chart illustrating an example of a wireless communication protocol between the communication device 20 and the wireless tags 15 (here, four wireless tags TG1 to TG4 are present). As described above, FIG. 7 illustrates an example on a basis of the protocol of ISO 18000-6 type C, and it is assumed that the number of slots per a round is set to “4”.

In FIG. 7, all symbols [Q], [R], [A], [ID], and [Qr] indicate communication data. A preamble code indicating the beginning of communication data is included in the beginning of each communication data item, and an error detecting code such as Cyclic Redundancy Check (CRC) code is included in each communication data item, so it is possible to detect an error on a reception side.

First, the communication device 20 transmits an unmodulated carrier signal as a radio wave from the antenna 22. Each of the wireless tags TG1 to TG4 is activated by receiving the radio wave. Next, the communication device 20 transmits Query command [Q] for instructing starting of a reading of a first round. A parameter (Q value=2) that sets the number of slots per round to “4” is included in Query command [Q]. When each of the wireless tags TG1 to TG4 receives Query command [Q], the tag generates a random number. Then, each of the wireless tags TG1 to TG4 determines using the random number which slot to respond in among the four slots in a round. In the same manner, each wireless tag generates response data [R] using the random number. Since response data [R] is generated using the random number, the response data [R] has a different value for each wireless tag. In addition, even in the same wireless tag, the response data [R] has a different value each time the random number is generated.

In the example of FIG. 7, the wireless tag TG2 transmits response data [R] in a first slot 0. If receiving response data [R] from the wireless tag TG2 is received at the communication device 20, the communication device 20 transmits an Acknowledge (Ack) command [A] instructing that the response data [R] has been correctly received. The response data [R] received from the wireless tag TG2 is included in the Ack command [A].

The wireless tag TG2 that has transmitted response data [R] waits for an Ack command [A]. Then, when the wireless tag TG2 receives Ack command [A], it confirms whether the response data [R] that it previously sent is included therein in the Ack command A. When the response data [R] is recognized as included, the wireless tag TG2 identifies that Ack command [A] is addressed to itself and transmits its ID information [ID] stored in its own memory.

The communication device 20 detects the presence or absence of an error when receiving ID information [ID]. When there is no error, the communication device 20 stores the received ID information [ID] as tag read information 351 in the storage unit 35. ID information [ID] corresponds to the wireless tag identification information of FIG. 6.

Next, the communication device 20 transmits Query-rep command [Qr] so as to cause a slot switch. The wireless tag TG2 that has already transmitted response data [R] does not respond in the next slot even if it receives the Query-rep command [Qr]. In the example of FIG. 7, the wireless tag TG1 transmits response data [R] in a second slot 1. Since the subsequent operations in the second slot 1 are the same as the operations in the first slot 0, the description thereof will be omitted. Once communication in the second slot 1 is ended, the communication device 20 transmits Query-rep command [Qr] so as to instruct a slot switching. Again, the wireless tags TG1 and TG2 that have already transmitted response data [R] do not respond even if receiving Query-rep command [Qr] in a subsequent time slot.

In the example of FIG. 7, the wireless tags TG3 and TG4 each transmit different response data [R] in a third slot 2. Since the transmission start time of response data [R] is defined as within a predetermined time from when Query command [Q] or Query-rep command [Qr] is received, if two or more wireless tags respectively transmit response data [R] in the same slot, a portion of response data [R] being transmitted collides, i.e., interferes at the communication device 20. Therefore, the communication device 20 is not able to receive response data [R] of the wireless tag TG3 and response data [R] of the wireless tag TG4, and the communication device 20 detects reception timeout of response data [R].

Next, the communication device 20 transmits Query-rep command [Qr] to instruct a slot switching and starts a fourth time slot 3. However, in the example of FIG. 7, since the wireless tags TG1 to TG4 have already transmitted response data [R] in a round 1, response data [R] is not transmitted by the tags in the fourth slot 3, and the communication device 20 detects a reception timeout of response data [R], i.e., no response is received during the timed reception period.

The communication device 20 detects the end of the four slots of round 1, and transmits Query command [Q] instructing a start of a first slot 0 of a new round 2. In the example of FIG. 7, the wireless tags TG1 and TG2 that have transmitted ID information [ID] do not respond in the second and subsequent rounds, because they received a response from the communication device 20 during the first round of time slots. In the first slot 0 of round 2, the wireless tag TG4 transmits response data [R]. Since the remaining operations of the first slot 0 in the round 2 are the same as the operations of the first slot 0 in the round 1, the description thereof will be omitted.

When communication is ended in the first slot 0 of the round 2, the communication device 20 transmits Query-rep command [Qr] instructing a slot switch. In a second slot 1 of the round 2, the wireless tag TG3 transmits response data [R]. If the communication device 20 receives response data [R] from the wireless tag TG3, it transmits Ack command [A] instructing that the response data [R] has been correctly received. For example, FIG. 7 illustrates an example in which the wireless tag TG3 is located in the shadow of products, the signal of Ack command [A] that is transmitted by the communication device 20 is attenuated, and thus the wireless tag TG3 detects a reception error at the time of receiving Ack command [A], i.e., a proper received and acknowledgement signal is not received by tag TG3.

The communication device 20 waits for reception of ID information [ID] from the wireless tag TG3 after transmitting Ack command [A]. However, when there is reception timeout before the ID information is received, the communication device 20 changes a current slot to a next slot in the same manner. Hereinafter, the communication device 20 communicates with a plurality of wireless tags in a store by the normal read function, and receives ID information [ID] in the same sequence as previously described.

Returning to FIG. 5A, the controller 34 determines whether the normal read function has read tag identification information (Act A5). When the tag identification information has been read, the read tag identification information is stored in the storage unit 35 according to the read order value.

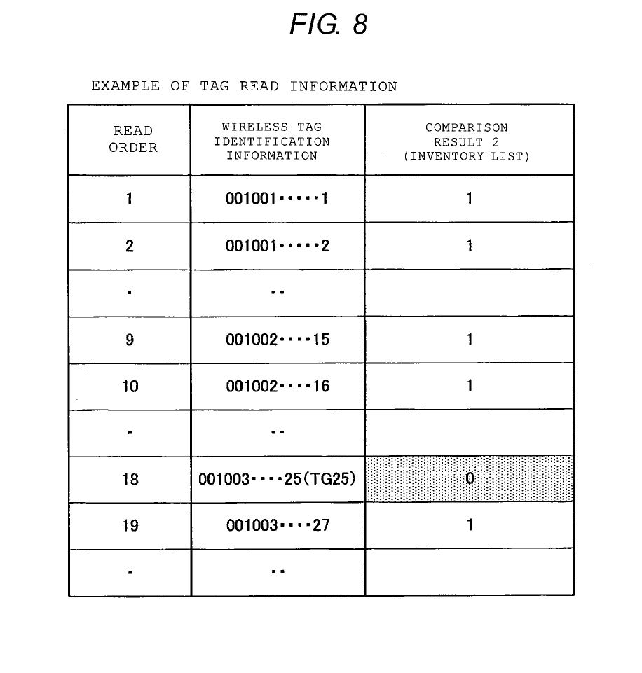

FIG. 8 illustrates an example of the tag read information 351 of the storage unit 35. The controller 34 does not repeatedly store the same tag identification information as the tag read information 351 that is stored in advance in the storage unit 35. Further, the comparison unit 37 compares the tag read information 351 with the tag identification information in the inventory list 352. When there is a tag identification information 351 that has been read that is not present in the inventory list 352, “0” is stored in the comparison result 2. When the tag identification information 351 that has been read is present in the inventory list 352, “1” is stored in the comparison result 2 and the comparison result 1 (FIG. 6) of the wireless tag identification information corresponding to the inventory list 352 is changed to “1” (Act A6). Then, the process returns to Act A4. In addition, in Act A5, when the reading of the tag identification information is not detected, the process returns to Act A4 as it is, and repeats act A4 to A6.

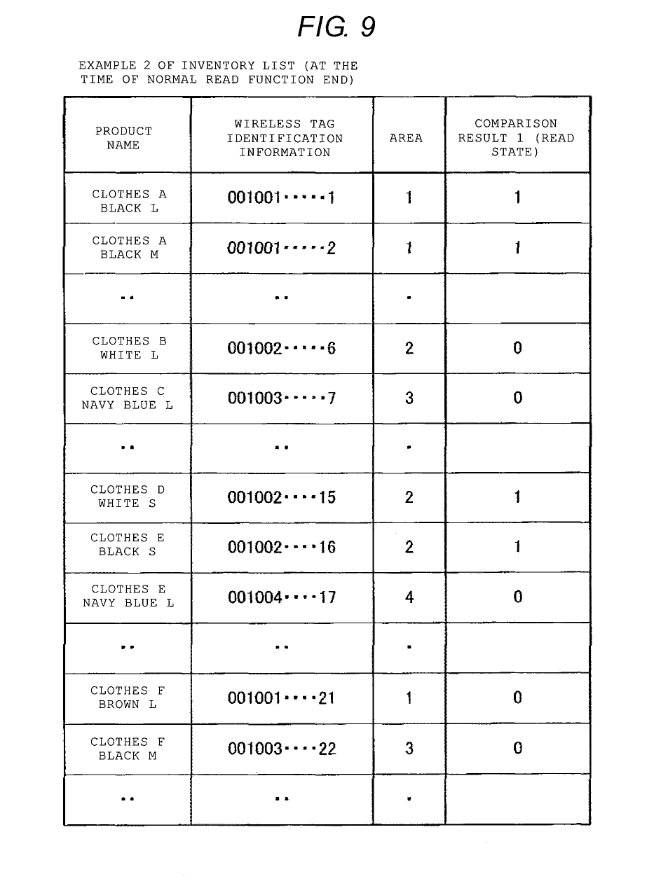

The operator performs a read operation by the normal read function from a point A to a point B through a dotted route in FIG. 1, and performs the key input of the normal read function end in the input unit 25. If the key input of the normal read function end is detected (at the time of YES in Act A4), the controller 34 ends the normal read function. FIG. 9 illustrates an example of an inventory list at the time of the normal read function end. Further, if the normal read function is ended, the process proceeds to Act A7 of FIG. 5B.

Next, the controller 34 detects the number of wireless tags for which the comparison result 1 of the inventory list 23 is 0, that is, the number of the wireless tags in the inventory list 352 (Act A7) which remain unread. When there are no unread wireless tags, an operation is ended (Act A8).

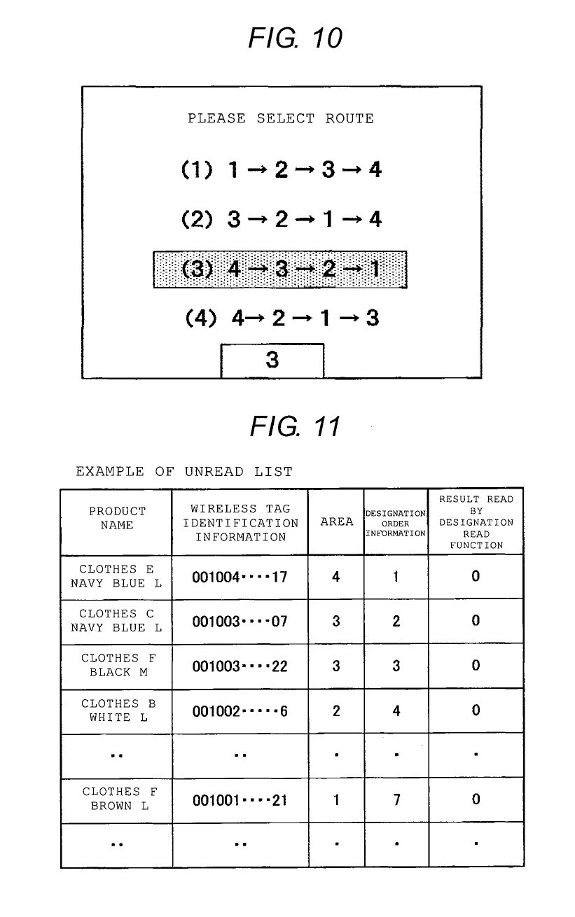

Further, when the number of unread wireless tags is two or more (Act A9), the controller 34 sets route information that is input by the input unit 25 as route information 354 of the storage unit 35 (Act A10). That is, as shown in FIG. 10, a screen promoting a route is displayed on the display 24, and route information selected from number keys of the input unit 25 is stored in the storage unit 35. In the present embodiment, route choices stored in advance in the storage unit 35 are displayed, and route information selected by the input unit 25 is stored in the storage unit 35 so as to set route information 354.

The example of FIG. 10 illustrates an example in which the shaded route of area 4→area 3→area 2→area 1 is selected. In other words, in FIG. 1, the operator sets a read operation by the designation read function in a route opposite to the case of the normal read, from point B to point A. In addition, in the present embodiment, a case where the number of designation tags of the designation read function is set to “2” will be described. The number of designation tags of the designation read function feature will be described later herein.

Next, the unread list generation unit 39 generates the unread list 353 (list of tags expected to be read which were not found) on a basis of route information 354 stored in the storage unit 35 (Act A11). The unread list 353 includes designation order information of the reading by the designation read function.

In other words, starting from the beginning of the inventory list shown in FIG. 9, first, the information of the wireless tags in which the comparison result 1 is “0” and an area is “4” is extracted and is stored in the unread list 353. In the same manner, the information of the wireless tags for which the comparison result 1 is “0” and an area is “3”, the information of the wireless tags in which a comparison result 1 is “0” and the area is “2”, and the information of the wireless tags in which a comparison result 1 is “0” and the area is “1” are respectively extracted in this order to generate the unread list 353.

FIG. 11 illustrates an example of the unread list. The unread list includes a product name, wireless tag identification information, an area, designation order information and a result read by the designation read function. “0” is stored in the result read by the designation read function at the time of generating the unread list. When it is determined that a wireless tag has been read by the designation read function, the controller 34 changes the read result to “1”.

Returning to FIG. 5B, when the number of unread wireless tags is 1 (Act A9), it is not necessary to generate the unread list. Therefore, the product name, the wireless tag identification information, and area that correspond to the unread wireless tag are displayed on the display 24, and “1” is set in the number of designation tags of the designation read function (Act A12).

Next, as shown in FIG. 5B, the controller 34 sets the designation read function in the function setting unit 73 of the communication controller 36 (Act A13). In other words, a transmission output setting signal corresponding to a transmission output of the designation read function that is set in advance is output from the transmission output setting unit 71, a transmission signal of the designation read function is output from the transmission controller 72, and the transmission controller 72 sets a timing of transmission, and the like.

Next, the designation read function is started (Act A14). If the transmission output setting signal is output from the transmission output setting unit 71, an unmodulated carrier signal is radiated as a radio wave from the antenna 22. If the transmission signal is output from the transmission controller 72, transmission is performed with respect to the wireless tag 15. For example, a determination of whether there is a key input of the designation read function end from the input unit 25 (Act A15) is made, and the controller 34 continues the designation read function until the input is detected.

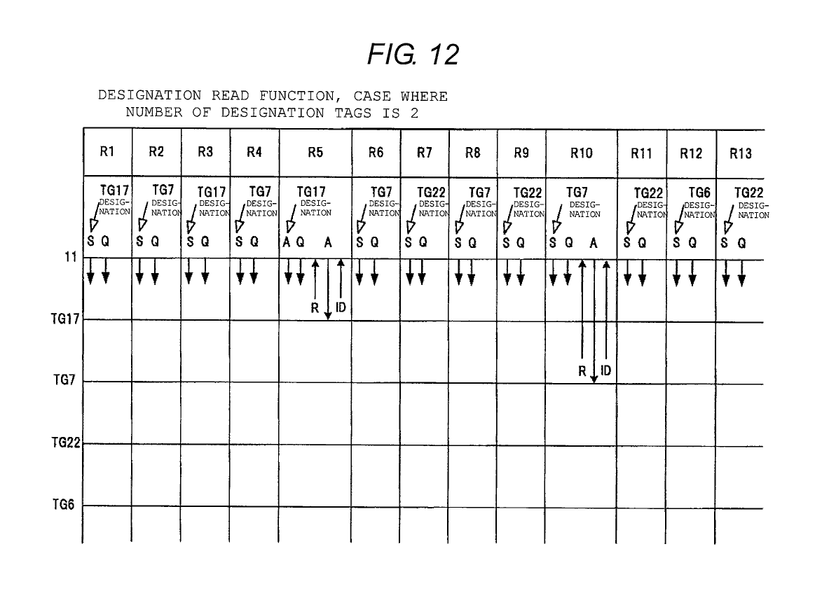

FIG. 12 is a timing chart illustrating a communication example of the designation read function between the communication device 20 and four wireless tags TG17, TG7, TG22, and TG6 (a case where the number of designation tags is 2). As shown in FIG. 11, designation order information of the wireless tags TG17, TG7, TG22, and TG6 is respectively set to 1, 2, 3 and 4. Further, similar to FIG. 7, FIG. 12 illustrates an example on a basis of the protocol of ISO 18000-6 type C, and it is assumed that the number of slots per a round is set to “1”.

Similar to FIG. 7, all symbols [S], [Q], [R], [A] and [ID] indicate communication data. A preamble code indicating the beginning of communication data is included in the beginning of each communication data item, and an error detecting code such as Cyclic Redundancy Check (CRC) sign is included in each communication data item except for [S], thereby it is possible to detect an error on a reception side.

First, the communication device 20 transmits an unmodulated carrier signal as a radio wave from the antenna 22.

Next, the communication device 20 transmits Select command [S], and subsequently Query command [Q], and starts a first round R1. Select command [S] of the round R1 sets wireless tag identification information such that only wireless tag TG17 of which designation order information is “1” responds. When wireless tags other then the wireless tag TG17 receive Select command [S] and Query command [Q], the wireless tag determines that identification information different from its own identification information is designated, and does not transmit a response signal [R]. The first round R1 shows a case where the communication device 20 has detected a reception timeout while the communication device 20 waits for the response signal [R], due to a reason that a sufficient radio wave does not reach the wireless tag TG17.

After the end of the round R1, the communication device 20 transmits Select command [S] which sets wireless tag identification information such that only wireless tag TG7 of which designation order information is “2” responds and Query command [Q], and starts a second round R2. Similar to the first round R1, the second round R2 shows a case where the communication device 20 has again encountered a reception timeout while the communication device 20 waits for the response signal [R].

After the end of the round R2, the communication device 20 transmits Select command [S] which sets wireless tag identification information such that only wireless tag TG17 of which designation order information is “1” responds and Query command [Q], and starts a third round R3. In this manner, FIG. 12 is an example of a case of setting the number of designation tags to “2”, and two wireless tags are alternately designated and thus individually searched out in the inventory store. That is, the wireless tag TG17 is designated in an odd number-th round and the wireless tag TG7 is designated in an even number-th round.

In addition, in a case of setting the number of designation tags to “1”, identically one type of wireless tag identification information is set in Select command [S] of each round. In a case of setting the number of designation tags to “3”, three types of wireless tag identification information are repeatedly designated for searching in order for each round. That is, a first wireless tag, a second wireless tag and a third wireless tag are respectively designated in a remaining first round, a remaining second round and a remaining third round.

If the operator approaches nearby to the wireless tag TG17 while performing the read operation by the designation read function, as an example of the round R5 of FIG. 12, the communication device 20 can correctly receive ID information [ID] from the wireless tag TG17, after transmitting Select command [S] that sets the wireless tag identification information of the wireless tag TG17 and Query command [Q].

If receiving ID information [ID] corresponding for the tag being searched in the round, the controller 34 changes the result read by the designation read function of the wireless tag TG17 of the unread list 353 to “1” and designates the wireless tag TG7 in round R6, and thereafter the controller 34 designates the wireless tag TG22 of designation order information “3” in the next round R7. Subsequently, similarly, the controller 34 designates the wireless tag TG7 in the round R8, and then designates the wireless tag TG22 as the tag to be searched in the round R9, i.e., the information concerning found tag TG17 is replaced with that of missing tag TG22.

Then, if the communication device 20 designates the wireless tag TG7 in a round R10 and receives ID information [ID] from the wireless tag TG7, the controller 34 changes the result read by the designation read function of the wireless tag TG7 of the unread list 353 to “1”. Further, after designating the wireless tag TG22 as the tag to locate in round R11, the controller 34 designates a wireless tag TG6 of designation order information “4” in a next round R12.

In this manner, in the designation read function that sets the number of designation tags to “2”, a round is repeated which alternately designates one of two different wireless tags in the designated order values. In a case of correctly receiving ID information [ID] from a wireless tag, the controller 34 designates another wireless tag in the next designation order value.

Returning to the flowchart of FIG. 5B, after the designation read function is started (Act A14), the controller 34 determines whether there is the key input of the designation read function end from the input unit 25 (Act A15). In a case of detecting the input, the designation read function is ended.

When the key input of the designation read function end is not detected, the controller 34 determines whether there is a designation change input from the input unit 25 (Act A16). When it is not possible to easily read the tag identification information in the read operation by the designation read function, the operator presses the designation change input key of the input unit 25.

When there is a designation change input from the input unit 25, the controller 34 changes the process in order to designate the lowest wireless tag in specification order that is not yet designated in the unread list 353 by the Select command [S] (Act A17). Further, although not shown, a threshold of the number of rounds to be designated is given to a wireless tag. If the number of rounds exceeds the threshold, the tag to be designated may be changed. If there is no designation change input from the input unit 25, the controller 34 does not change the designation of the wireless tag.

Next, the controller 34 determines whether the wireless tag identification information has been read (Act A18). When it is detected that the wireless tag identification information has been read, the controller 34 changes the read result of the read wireless tag to “1” in the unread list 353 of the storage unit 35 (Act A19). In addition, the controller 34 changes the designated wireless tag to a wireless tag of a subsequent designation order value. Further, the controller 34 changes the comparison result 1 of the read wireless tag in the inventory list 352 (FIG. 9) to “2”. Then, the process returns to Act A15.

Further, when the wireless tag identification information has not been read in Act A18, the process, as it is, returns to Act A15, and repeats Act A15 to Act A19. Moreover, the controller 34 determines whether there is the key input of the designation read function end from the input unit 25 (Act A15). When the key input of the designation read function end is detected, the controller 34 ends the process.

In this manner, it is possible to automatically generate the unread list 353 by reading the unread wireless tag by the designation read function having a higher read success rate than the reading by the normal read function, according to designated route information.

As described above, after the read operation by the normal read function from point A to point B in FIG. 1 is performed, the route information is designated and the read operation to locate tags which were not located during the normal read function in the pass through the inventory store is performed by the operator using the designation read function in the reverse of the route to point A from point B. Therefore, it is possible to greatly improve the read rate of the wireless tags in the inventory list.

Therefore, it is possible to shorten the time required for the inventory work, and to efficiently perform inventory work. Further, the operator does not have to move back and forth many times in the store, so burden on the operator becomes lighter.

Further, in the first embodiment, when a reading of a tag is completed by a read operation by the normal read function, the value “1” is stored in the comparison result of each product and read wireless tag of the inventory list 352, whereas when a reading is performed by a read operation by the designation read function to located tags which were not found during the normal read function, the value of “2” is stored, thereby it is possible to easily leave history information in the inventory work.

### Second Embodiment

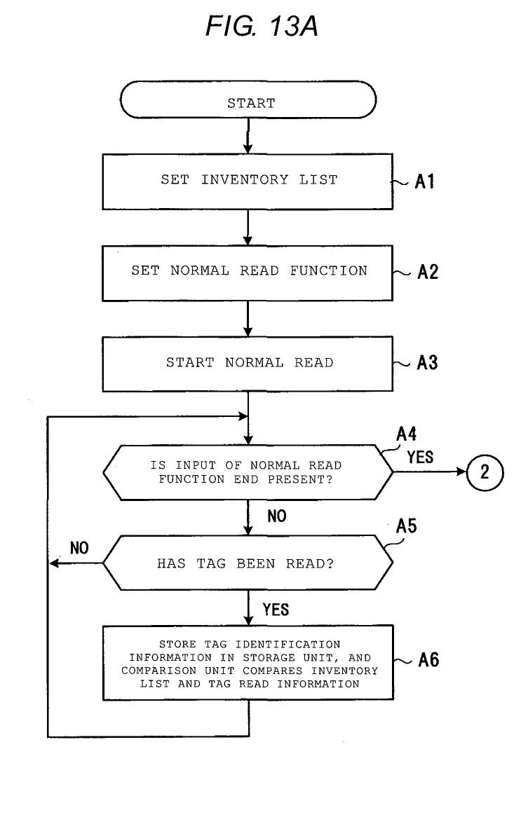

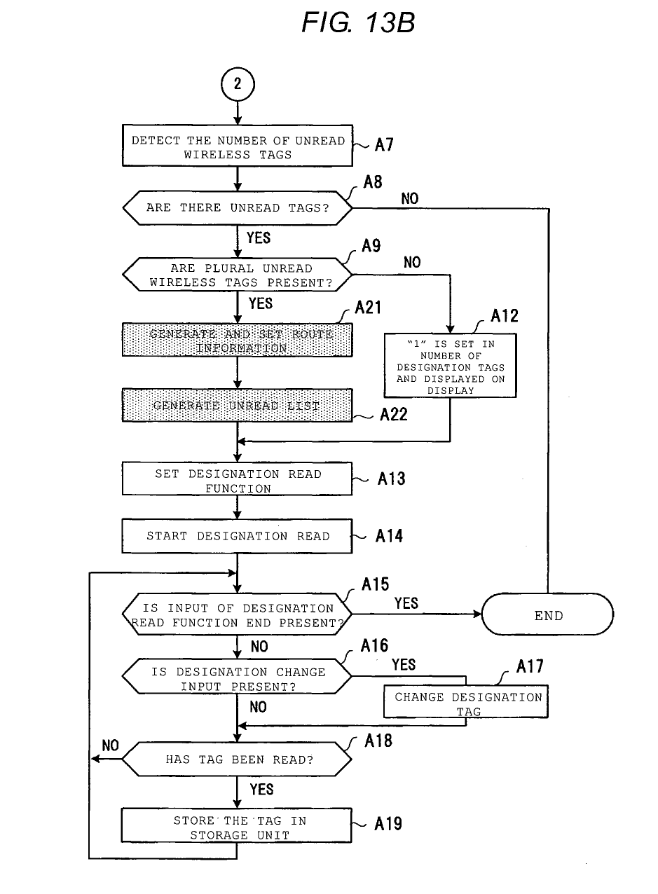

Next, a second embodiment in which route information 354 of the storage unit 35 has other aspects will be described with reference to FIGS. 13A to 15.

FIGS. 13A and 13B are flowcharts illustrating a processing procedure of the controller 34 when performing inventory work by the communication device 20, in the second embodiment. Steps (operations) common to processing procedures of FIGS. 5A and 5B of the first embodiment are denoted by the same reference numerals.

That is, in the second embodiment, when it is determined that a plurality of wireless tags should be present (Act A9) but have not been read during the normal read function, the route information generation unit 38 of the controller 34 generates route information and sets the generated route information in the route information 354 of the storage unit (Act A21). Further, in the description of the second embodiment, it is assumed that the route reverse to the route of the reading by the normal read function is set in advance, as route information of the reading by the designation read function to locate tags which were not read in the normal read function.

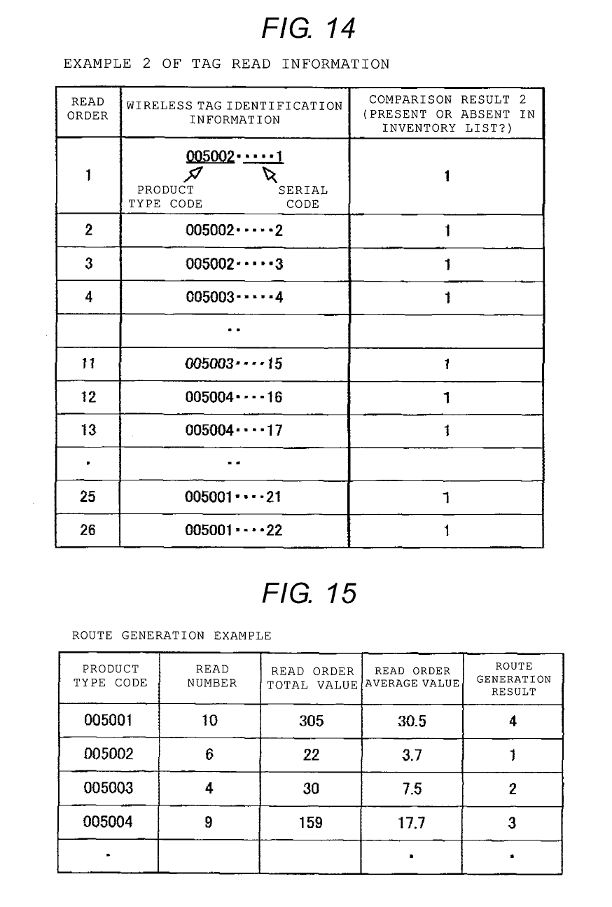

FIG. 14 illustrates an example of tag read information 351 after the read operation by the normal read function is ended (at the time of YES in Act A4). As shown in FIG. 14, the identification information of the wireless tag attached to each of the products includes, for example, a product type code of 6 digits, and the products are arranged and disposed in the store for each product type.

As shown in FIG. 15, the route information generation unit 38 of the controller 34 calculates the read order average value for each product type code from the read order value of the tag read information and the product type code of the wireless tag identification information that are shown in FIG. 14.

First, for the first row of FIG. 14, read order value “1” and product type code “005002” are read. In FIG. 15, the reading number of the product type code “005002” is set to “1”, and a read order total value is set to “1”, whereby a read order average value is calculated in the following (Equation 2) and read order average value is set to “1”.

Read order average value=read order total value/number read (Equation 2)

Next, for the second row of FIG. 14, read order value “2” and product type code “005002” are read. In FIG. 15, the number of the product type code “005002” read is set to “2”, and a read order total value is set to “3” (sum of the read order numbers of all tags having the same product type code and having a comparison result value of 1), whereby a read order average value is calculated in the Equation 2 and the read order average value is set to “1.5”. The same process is performed for all tag read information of FIG. 14, whereby a read order average value is calculated for each product type code.

Next, the smallest read order average value is detected, and the route generation result is set to “1”. A second smallest read order average value is detected, and in the same manner, the route generation result is set to “2”. For all product identification codes, the new route generation results are stored in the same manner. Then, the controller 34 determines that the operator has performed the read operation by the normal read function in routes in an ascending order of the route generation result.

That is, the read order values (1, 2, . . . , 26) of FIG. 14 indicate order values that have been read by the normal read function.

Further, in the example of FIG. 15, it is shown that wireless tags attached to products of “005001” have been read ten times, the total value of the ten read order values (25+26+ . . . ) is 305, and the read order average value is 30.5 (=305/10).

Further, it is shown that wireless tags attached to products of “005002” have been read six times, the total value of six read order values (2+3+ . . . ) is 22, and the read order average value is 3.7 (=22/6). In the same manner, it is shown that the read order average value of the products indicated by a product code of “005003” is 7.5 and the read order average value of products indicated by a product code of “005004” is 17.7.

Then, depending on the route generation results, read order average values are arranged in an ascending order.

In the second embodiment, the route determined by the route generation result values of FIG. 15 is set in the route information 354 of the storage unit 35. In other words, the route information generation unit 38 sets all product type codes in the order from the product type code having a large route generation value of FIG. 15 to the smallest such value as the route information 354 of the storage unit 35. Next, the unread list generation unit 39 generates the unread list 353 from the route information 354 that is set and the inventory list 352 (Act A22).

In the second embodiment, the route information set by the product identification code is used. The unread list generation unit 39 first extracts information of a wireless tag in which the comparison result 1 of the inventory list 352 was “0” and the product identification code is the same as the product identification code that is set in the first route for finding unread or missing tags. Then, the unread list generation unit 39 stores in the unread list 353 product names, wireless tag identification information, areas, designation order information and results read by the designation read function. Similarly, the unread list generation unit 39 extracts the information of the corresponding wireless tag according to the route information, and stores the information in the inventory list 352.

Thus, without using the area information, it is possible to automatically detect the route information of the read operation by the normal read function. Therefore, even if products are rearranged by change in the layout or the like in the store, there is no need to change the product information of the storage unit 35 or the host device 100.

Further, in the second embodiment, when it is detected that a plurality of unread wireless tags are present (Act A9), the route information generation unit 38 generates route information. However, without being limited to the number of the unread wireless tags, after the read operation by the normal read function is ended, the route information generation unit 38 may generate route information. In this case, it is not necessary to generate route information of the route reverse to the route of the reading by the normal read, and the operator may input pieces of route information one at a time from the input unit 25. In addition, route information choices are displayed on the display 24, and the operator may select an input from the input unit 25.

Further, in the second embodiment, it is possible to simply and automatically set route information of the route reverse to that of the route of the normal read function as route information by the designation read function. Thus, as long as the operator knows only that a reading is performed in the route reverse to the route of the reading by the normal read function, the operator is able to perform a read operation by the designation read function and inventory work without inputting and setting the route information, thereby efficiently performing the inventory work.

### Third Embodiment

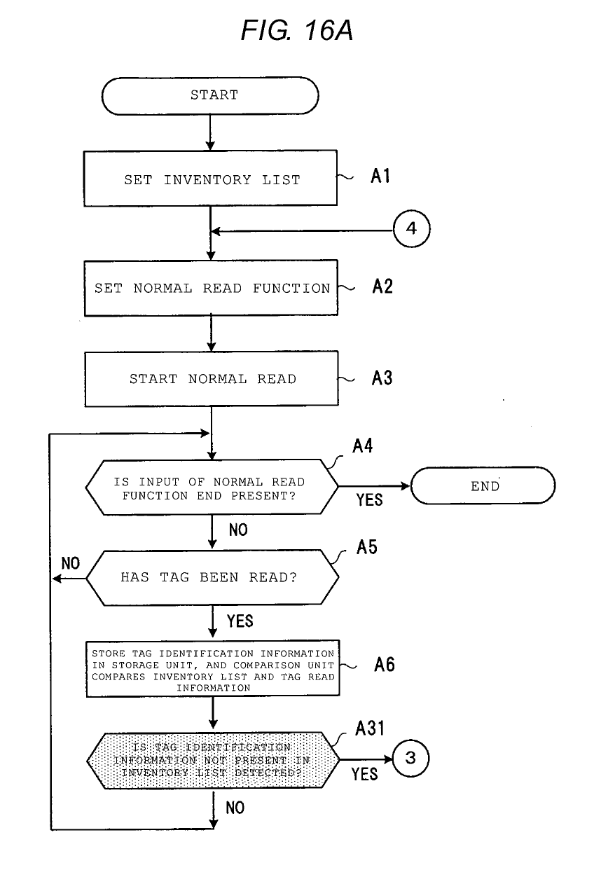

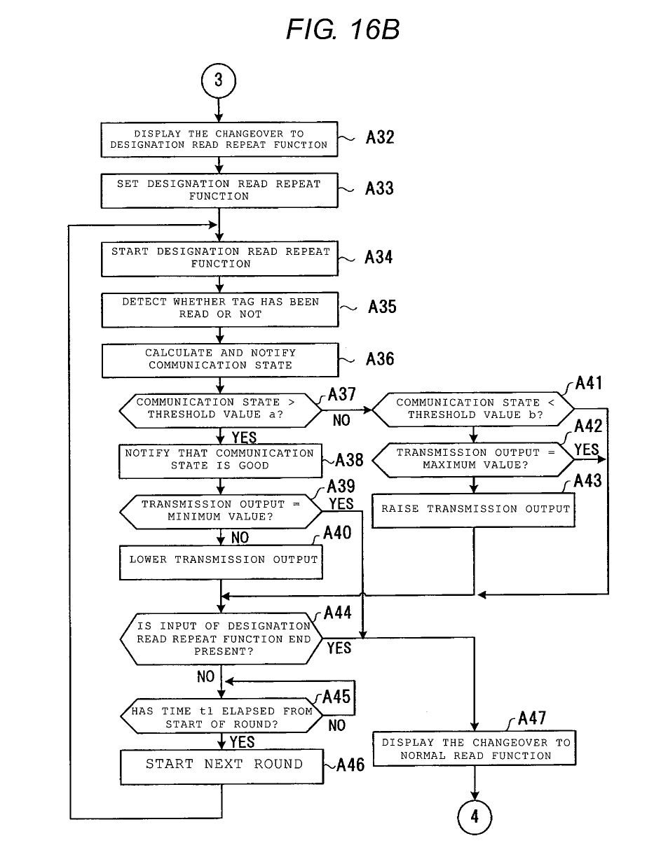

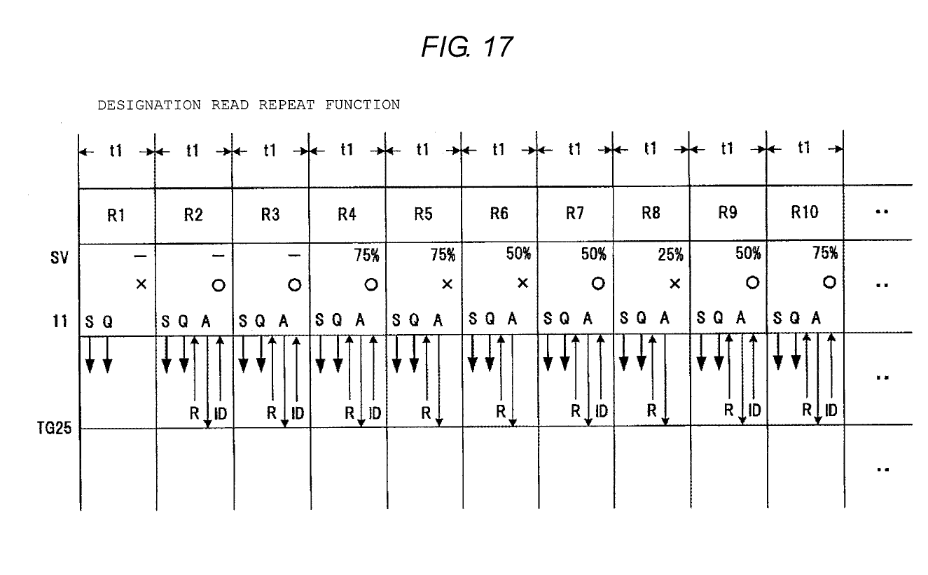

Next, a third embodiment in which the processing procedure of the controller 34 has other aspects will be described with reference to FIGS. 16A, 16B and 17.

FIGS. 16A and 16B are flowcharts illustrating a processing procedure of the controller 34, and steps (operations) common to those of FIGS. 5A, 5B, 13A and 13B are denoted by the same reference numerals.

In FIG. 16A, the comparison unit 37 compares the tag read information 351 that has been read by the normal read function with the inventory list 352. When the read wireless tag identification information is present in the inventory list 352, the comparison result 1 of the corresponding wireless tag of the inventory list 352 is set to “1”, and the comparison result 2 of the corresponding wireless tag of the tag read information 351 is set to “1” (Act A6). The controller 34 detects whether the wireless tags in which the comparison result 2 of the tag read information 351 is “0”, that is, the wireless tag not present in the inventory list 352 has been read (Act A31).

When the wireless tag not present in the inventory list 352 has not been read, the process returns to Act A4, and the read operation by the normal read function continues. On the other hand, when it is detected that the wireless tag not present in the inventory list 352 has been read, the read operation by the normal read function is interrupted, the process proceeds to the flow of FIG. 16B and the process changes over to the read operation by the designation read repeat function. Alternatively, the process may change over when the operator makes a key input of the designation read repeat function changeover of the input unit 25.

First, the controller 34 displays on the display 24 that the process will change over to the designation read repeat function (Act A32). Then, the function setting unit 73 of the communication controller 36 sets the designation read repeat function (Act A33). Further, a transmission output setting signal corresponding to an initial value of the transmission output of the designation read repeat function that is set in advance is output from the output setting unit 71. Further, the transmission signal of the designation read repeat function is output from the transmission controller 72, and the transmission controller 72 sets a timing of transmission and the like. Here, in order to simplify the explanation, the initial value of the transmission output is set to the maximum value of the transmission output that can be set in the communication device 20.

Further, a wireless tag (for example, a wireless tag TG25 of FIG. 8) not present in the inventory list 352 that is read by the read operation by the normal read function is set as an object of the designation read repeat function. Next, the read operation by the designation read repeat function is started (Act A34). In the following description, an example in which the designation read repeat function having the wireless tag TG25 as an object will be described.

When a transmission output setting unit 71 outputs a transmission output setting signal, an unmodulated carrier signal is radiated as a radio wave from the antenna 22. When a transmission signal is output from the transmission controller 72, transmission to the wireless tag occurs.

FIG. 17 is a timing chart illustrating an example of a wireless communication protocol between the communication device 20 and the wireless tag TG25 in the third embodiment. Similar to FIG. 12, FIG. 17 illustrates an example on a basis of the protocol of ISO 18000-6 type C, and it is assumed that the number of slots per a round is set to “1”.

All symbols [S], [Q], [R], [A] and [ID] indicate communication data. A preamble code indicating the beginning of communication data is included in the beginning of each communication data item, and an error detecting code such as Cyclic Redundancy Check (CRC) sign is included in each communication data item except for [S] so that it is possible to detect an error on a reception side.

Circles “O” in FIG. 17 mean the successful reception of ID information [ID] by the communication device 20 in each round. Symbols “x” mean the reception failure. First, as described above, the communication device 20 transmits the unmodulated carrier signal as the radio wave from the antenna 22. Then, the communication device 20 transmits Select command [S], and subsequently Query command [Q], and starts a first round R1. Select command [S] sets the identification information of the wireless tag TG25 such that only wireless tag TG25 being an object of the designation read repeat function, responds. When wireless tags other than the wireless tag TG25 receive Select command [S] and Query command [Q], they determine that identification information different from their particular identification information is designated, and the wireless tags do not transmit a response signal [R]. The first round R1 is an example in which the communication device 20 detects the reception timeout while waiting for the response signal [R], due to a reason that a sufficient radio wave has not reached the wireless tag TG25.

The communication device 20 transmits Select command [S] that sets the identification information of the wireless tag TG25 and subsequently Query command [Q] such that only wireless tag TG25 responds when time t1 has elapsed from the start of transmission of Select command [S] of the round R1, and starts a second round R2. The second round R2 shows a case where the communication device 20 has correctly received ID information [ID] from the wireless tag TG25. Hereinafter, similarly, the communication device 20 transmits Select command [S] that sets the identification information of the wireless tag TG25 and subsequently Query command [Q] such that only wireless tag TG25 responds when time t1 has elapsed from the start of transmission of Select command [S], and starts a next round. Rounds R5, R6, and R8 show an example in which after the communication device 20 has transmitted Ack command [A], the communication device 20 detects the reception timeout while waiting for ID information [ID] to fail in receiving ID information [ID].

Further, the controller 34 detects whether ID information [ID] has been correctly received or not in each round, and for example, calculates a communication success rate including the result of whether ID information [ID] of the previous three rounds has been received or not. In the example of FIG. 17, the communication success rate SV calculated in a round R4 becomes 75% from the result of whether ID information [ID] from round R1 to round R4 has been received or not. Communication success rate SV calculated in round R5 is 75% from the result of whether ID information [ID] from round R2 to round R5 has been received or not.

Returning to FIG. 16B, the controller 34 starts the read operation by the designation read repeat function (Act A34) and detects the result of whether ID information [ID] has been received or not in each round and calculates a communication state (Act A35). Here, the communication success rate SV is calculated as the communication state. Further, the calculated communication success rate SV may be displayed on the display 24 (Act A36).

Next, the controller 34 compares the calculated communication success rate SV with threshold value a (Act A37). When the communication success rate SV is greater than the threshold value a, it is determined that the communication state is good. For example, it is assumed that the threshold value a=70%. Further, when the communication success rate SV is greater than the threshold value a, the controller 34 displays a message such as “Since a wireless tag of the object is present in the direction of the antenna, please proceed in that direction” on the display 24 (Act A38).

Furthermore, the controller 34 compares the transmission output of the current communication device 20 with the minimum value of the transmission output in the designation read repeat function that is set in advance (Act A39). When the transmission output of the communication device 20 is set to the minimum value, the read range at the time of specifying an object wireless tag by a designation read repeat function is minimized. The initial value, the maximum value and the minimum value of the transmission output in the designation read repeat function are set in advance by the operator.

When the current transmission output is greater than the minimum value, the controller 34 lowers the transmission output by one step (Act A40), and narrows the read range. When the transmission output is the minimum value, “object wireless tag is present within the minimum read range” and “designation read repeat function is ended, and will change over to the normal read function” are displayed on the display 24 (Act A47).

When the communication success rate SV is equal to or less than the threshold value a, the controller 34 compares the communication success rate SV with the threshold value b (Act A41). When the communication success rate SV is smaller than the threshold value b, the controller 34 determines that the communication state is poor. For example, it is assumed that the threshold value b=30%.

The controller 34 compares the transmission output of the current communication device 20 with the maximum value of the transmission output in the designation read repeat function that is set in advance (Act A42). When the current transmission output is smaller than the maximum value, the controller 34 raises the transmission output by one step (Act A43).

Next, the controller 34 detects whether there is the key input of the designation read repeat function end from the input unit 25 (Act A44), when the input is detected, “since an input of the designation read repeat function end is detected, the process will change over to the normal read function” is displayed on the display 24 (Act A47), and the process returns to Act A2 of FIG. 16A. When an input of an end key is not detected, the designation read repeat function continues. If it is detected that a time t1 elapses from the start of the round (Act A45), the controller 34 transmits Select command [S] that sets the identification information of the wireless tag TG25 and subsequently Query command [Q], starts a next round (Act A46), returns to Act A34 and repeats the process.

By the read operation by the designation read repeat function, the operator is able to easily narrow the possible location range of the object wireless tag. During the read operation by the normal read function, if it is detected that the wireless tag not present in the inventory list 352 has been read, the normal read function is once interrupted, and the wireless tag can be specified and then the normal read function after the specification can be resumed.

Therefore, after the read operation by the normal read function is performed throughout all areas of a store, even if the wireless tag not present in the inventory list 352 has been read, it is not necessary for the operator to move for specification thereof. Thereby, it is possible to shorten the time required for the inventory work and efficiently perform the inventory work.

In addition, it is assumed that in FIG. 16A, if the key input of the normal read function end is detected (Act A4), the process is ended. However, the read operation by the designation read function may be performed according to (1) of FIG. 5B or (2) of FIG. 13B. Further, FIGS. 16A, 16B and 17 illustrate an example in which the communication state is determined using the communication success rate SV, but the communication state may be determined using the number of rounds that consecutively have received ID information [ID], the number of rounds that could not consecutively receive ID information [ID], or in other manners. Further, although FIGS. 16A, 16B and 17 show an example in which the time of each round is fixed to t1, the time of each round may be varied depending on whether ID information [ID] has been received or not.

Further, in the third embodiment, a case is described in which a reading by the designation read function is performed with respect to the unread list, but the third embodiment may be applied to a case of performing a reading by the designation read repeat function with respect to a list of wireless tags in a case of reading wireless tags not present in the inventory list, that is, a search list.

### Fourth Embodiment

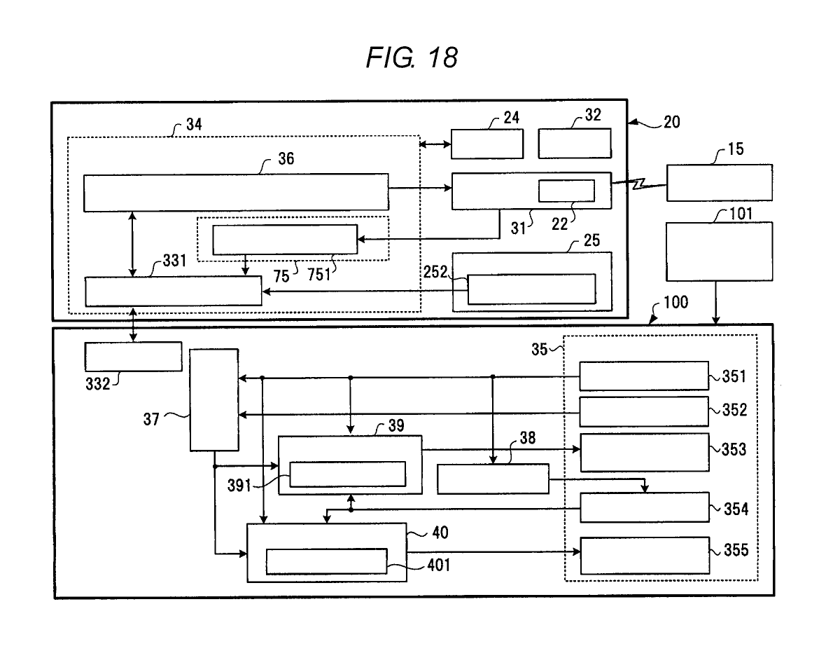

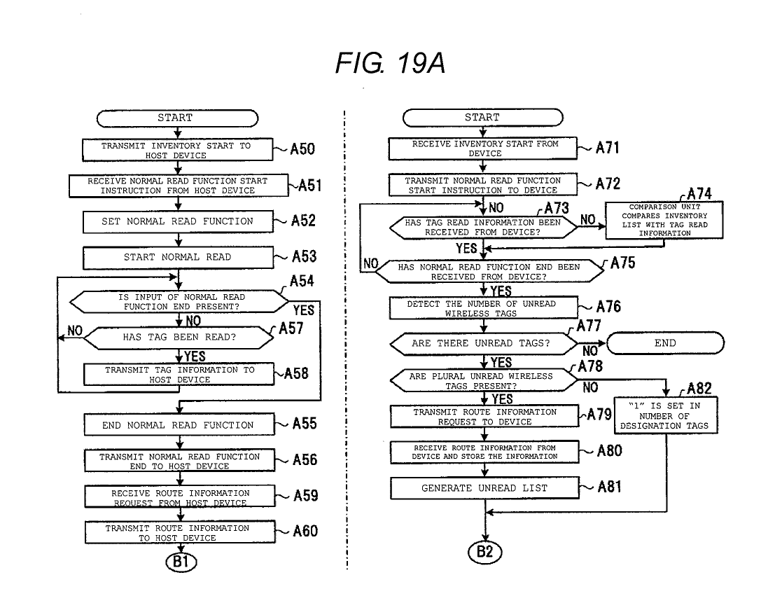

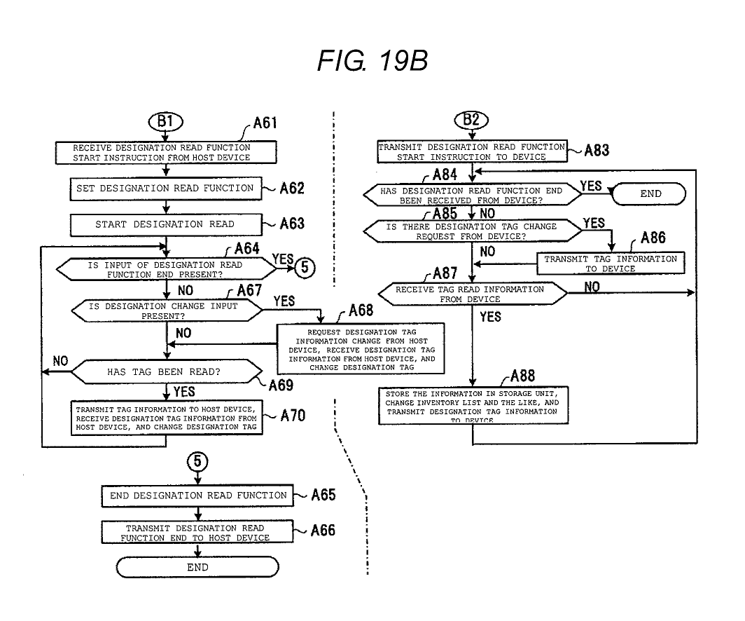

Next, a wireless tag communication system of a fourth embodiment will be described with reference to FIGS. 18 and 19.

FIG. 18 is a block diagram of a wireless tag communication system illustrating the fourth embodiment, the wireless tag communication system is configured by a wireless tag communication device 20 and a host device (server) 100, and the same reference numerals are attached to parts functionally the same as those of FIG. 3. Hereinafter, the wireless tag communication device 20 is called a communication device 20. The communication device 20 includes a power supply unit 32, a notification unit 24, an input unit 25, a communication unit 331 that communicates with a host device, a wireless tag communication unit 31, a controller 34, and a storage unit 75.

The power supply unit 32 is configured by a battery and a control circuit for charging and discharging of the battery. The notification unit 24 includes a display and a buzzer. The input unit 25 is configured by a keyboard or a touch panel that is installed on the display of the notification unit 24. The communication unit 331 performs a communication with the host device 100 connected through a communication line. The communication line may be configured in a wired manner or wireless manner.

The wireless tag communication unit 31 includes an antenna 22, and receives identification information and the like stored in the storage unit 16 of the wireless tag 15 by wirelessly communicating with the wireless tag 15. The controller 34 is mainly configured by a CPU, controls the input unit 25, the notification unit 24, the power supply unit 32, the communication unit 331 and the wireless tag communication unit 31 to control the whole communication device 20.

The controller 34 includes the storage unit 75 configured by a ROM and a RAM. The ROM stores in advance programs used by the controller 34, setting data and the like. Variable data is temporarily written to the RAM by the act of the controller 34. The RAM stores tag read information 751 including the wireless tag identification information that is received by the wireless tag communication unit 31. The tag read information 751 is transmitted to the host device 100 through the communication unit 331.

Further, the controller 34 includes a communication controller 36 that performs control of setting a transmission output, transmission data and the like in the wireless tag communication unit 31 and receives the reception data and the like. The input unit 25 includes a route information setting unit 252 and inputs the route information in the read operation of the designation read function. The input route information is transmitted to the host device 100 through the communication unit 331.

Further, the host device 100 includes a storage unit 35, a comparison unit 37, a route information generation unit 38, an unread list generation unit 39, a search list generation unit 40, and a communication unit 332.

The storage unit 35 stores tag read information 351 transmitted from the communication device 20, an inventory list 352 that is information of products that should be placed in a store, an unread list 353 that identifies the wireless tags that are present in the inventory list 352 but are not present in the tag read information 351, route information 354, a search list 355 that identifies wireless tags that are not present in the inventory list 352 but are received in the wireless tag communication unit 31, and the like.

Further, the communication unit 332 communicates with the communication device 20, and the comparison unit 37 compares the tag read information 351 with the inventory list 352. The unread list generation unit 39 includes a designation order information generation unit 391, and generates an unread list 353 including designation order information from the tag read information 351, the comparison result of the comparison unit 37 and the route information 354. The search list generation unit 40 includes a designation order information generation unit 401, and generates a search list 355 including designation order information from the tag read information 351, the comparison result of the comparison unit 37 and the route information 354, and the route information generation unit 38 generates route information from the tag read information 351.

The product area information input unit 101 inputs area information that is a part of the product information stored in the storage unit 35 of the host device 100, and performs an input when areas (positions), in which products are disposed, have been changed.

FIGS. 19A and 19B are flow charts illustrating a processing procedure of the communication device 20 and the host device 100 in the fourth embodiment. The left parts of FIGS. 19A and 19B illustrate the processing procedure of the controller 34 of the communication device 20, and the right parts of FIGS. 19A and 19B illustrate the processing procedure of the host device 100.

If it is detected that an inventory start key of the input unit 25 is operated by the operator, the controller 34 transmits “inventory start” to the host device 100 through the communication unit 331 (Act A50).

Once receiving the “inventory start” through the communication unit 332 (Act A71), the host device 100 transmits an instruction of “start of a read operation by the normal read function” to the communication device 20 through the communication unit 332 (Act A72). Further, the communication device 20 may transmit a transmission output and the like at the time of performing the read operation by the normal read function, or may instruct using a transmission output in a case of performing a read operation by the normal read function stored in advance in the storage unit 75 of the communication device 20.

If receiving the instruction of “start of the read operation by the normal read function” from the host device 100 (Act A51), the controller 34 sets the normal read function in the function setting unit 73 of the communication controller 36 (FIG. 4) (Act A52). In other words, a transmission output setting signal corresponding to the transmission output of the normal read function that is set in advance is output from the transmission output setting unit 71. A transmission signal of the normal read function is output from the transmission controller 72, and the transmission controller 72 sets a timing of transmission, and the like.

Next, the normal reading is started (Act A53). When a transmission output setting signal is output from the transmission output setting unit 71, an unmodulated carrier signal is radiated as a radio wave from the antenna 22. When the transmission signal is output from the transmission controller 72, a transmission is performed with respect to the wireless tag 15.

The controller 34 detects whether there is, for example, the key input of the normal read function end from the input unit 25 (Act A54), and when the input is detected, the read operation by the normal read function is ended (Act A55), and “end of the read operation by the normal read function” is transmitted to the host device 100 (Act A56).

On the other hand, when the key input of the normal read function end from the input unit 25 is not detected, it is determined whether the tag identification information has been read in the normal read function (Act A57), and when it is determined that the tag identification information has been read, the read tag identification information is stored in the storage unit 75 in a read order. Further, the tag identification information that has been read is transmitted to the host device 100 through the communication unit 331 (Act A58). Then, the process returns to (Act A54).

Once receiving the tag identification information that has been read from the communication device 20 (Act A73), the host device 100 stores the information in the order in which it was received as tag read information in the storage unit 35. In addition, the host device 100 does not repeatedly store the same tag identification information as the tag identification information 351 stored in the tag read information of the storage unit 35. Further, the comparison unit 37 compares the tag read information 351 with the inventory list 352.

When the tag read information 351 that is received is not present in the inventory list 352, “0” is stored in the comparison result 2 of wireless tag identification information of the tag read information 351. When the received tag read information 351 is present in the inventory list 352, “1” is stored in the comparison result 2 of wireless tag identification information corresponding to the tag read information 351 and the comparison result 1 of the wireless tag identification information corresponding to the inventory list 352 is changed to “1” (Act A74). Then, when “end of the read operation by the normal read function” is not received from the communication device 20 (at the time of NO in Act A75), the process returns to Act A73.

Next, if “end of the read operation by the normal read function” from the communication device 20 (at the time of YES in Act A75) is received, the host device 100 detects the number of the wireless tags in which the comparison result 1 of the inventory list 352 is 0, that is, the number of unread (not located) wireless tags in the inventory list 352 (Act A76). When unread wireless tags are not present in the list, the process is ended (Act A77).

When the number of unread wireless tags is two or more (at the time of YES in Act A78), the host device 100 transmits a “route information request” to the communication device 20 (Act A79).

If “route information request” is received from the host device 100 (Act A59), as an example shown in FIG. 10, the communication device 20 displays a screen promoting a route information input on the display 24, and transmits route information selected in the number keys of the input unit 25 to the host device 100 (Act A60).

If the host device 100 receives route information from the communication device 20, the host device 100 stores the route information in the storage unit 35 (Act A80). Next, the unread list generation unit 39 generates an unread list 353 including designation order information of reading by the designation read function on a basis of the route information 354 stored in the storage unit 35 (Act A81). In other words, from the beginning of the inventory list 352 shown in FIG. 9, the information of a wireless tag in which a comparison result 1 is “0” and an area is “4” is extracted first and stored in the unread list 353. In the same manner, the information of wireless tags in which a comparison result 1 is “0” and an area is “3”, the information of wireless tags in which a comparison result 1 is “0” and an area is “2”, and the information of wireless tags in which a comparison result 1 is “0” and an area is “1” are respectively extracted in this order to generate the unread list 353.

FIG. 11 illustrates an unread list generation example. “0” is stored in the area of the result read by the designation read function at the time of generating the unread list. When a wireless tag has been read by the designation read function, the controller 34 changes the result read by the corresponding designation read function to “1”.

When the number of the unread wireless tags is 1 (at the time of NO in Act A78), “1” is set in the number of designation tags of the designation read function (Act A82). In addition, it is described that when a plurality of unread wireless tags are present, “2” is set in the number of designation tags of the designation read function.

Hereinafter, the flowchart of FIG. 19B will be described. The host device 100 transmits an instruction of “designation read function start” including the number of designation tags of the designation read function and the identification information (tag ID) of the designation tag to the wireless tag communication device 11 (Act A83).

If the communication device 20 receives the instruction “designation read function start” from the host device 100 (Act A61), the communication device 20 sets the designation read function in the function setting unit 73 of the communication controller 36, and the transmission output setting signal, corresponding to the transmission output of the designation read function that is set in advance, is output from the transmission output setting unit 71. Further, the transmission signal of the designation read function is output from the transmission controller 72, and the transmission controller 72 sets a timing of transmission, and the like (Act A62).

Next, the controller 34 starts a designation reading (Act A63). In other words, if the transmission output setting signal is output from the transmission output setting unit 71, an unmodulated carrier signal is radiated as a radio wave from the antenna 22. Then when a transmission signal is output from the transmission controller 72, a transmission is performed with respect to the wireless tag 15.

The controller 34 detects whether there is the key input of the designation read function end from the input unit 25 (Act A64), and the designation read function continues until the input is detected. Further, when the key input of the designation read function end is detected, the read operation by the designation read function is ended (Act A65), and “designation read function end” is transmitted to the host device 100 (Act A66). If the host device 100 receives “designation read function end” from the communication device 20 (Act A84), the process is ended.

Next, it is detected whether there is an input of a designation change key of the input unit 25 (Act A67), and when there is the input, the controller 34 transmits “designation tag information change request” to the host device 100 (Act A68).

If the host device 100 receives “designation tag information change request” (Act A85), the host device 100 transmits the identification information of the wireless tag of a next designation order value of the wireless tag that is being designated to the communication device 20 (Act A86). Then, the communication device 20 receives the identification information (Act A68), and sets the received identification information in Select command [S]. Subsequently, it is determined whether wireless tag identification information has been read (Act A69). When the reading is detected, the controller 34 transmits the read tag information to the host device 100 (Act A70).

If the host device 100 receives the read tag information from the communication device 20 (Act A87), in the unread list 353 of the storage unit 35, the result read by the designation read function corresponding to the read wireless tag is changed to “1”, the comparison result corresponding to the read wireless tag in the inventory list 352 is changed to “2”, and the identification information of the wireless tag of the next designation order information is transmitted to the communication device 20 (Act A88). Then, the process returns to Act A84. Moreover, in Act A87, when the wireless tag identification information has not been read, the process returns to Act A84, and the operation is repeated. The communication device 20 receives tag information that will be designated next time, from the host device 100, sets the received identification information to Select command [S] and continues the designation read function (Act A70).

In this manner, even in a configuration of the fourth embodiment, similar to the first embodiment, it is possible to automatically designate the unread wireless tag according to the designated route information in the reading by the designation read function having a higher read success rate than the reading by the normal read function, and to generate the unread list 353. Therefore, it is possible to greatly improve the read rate of wireless tags in the inventory list.

### Fifth Embodiment

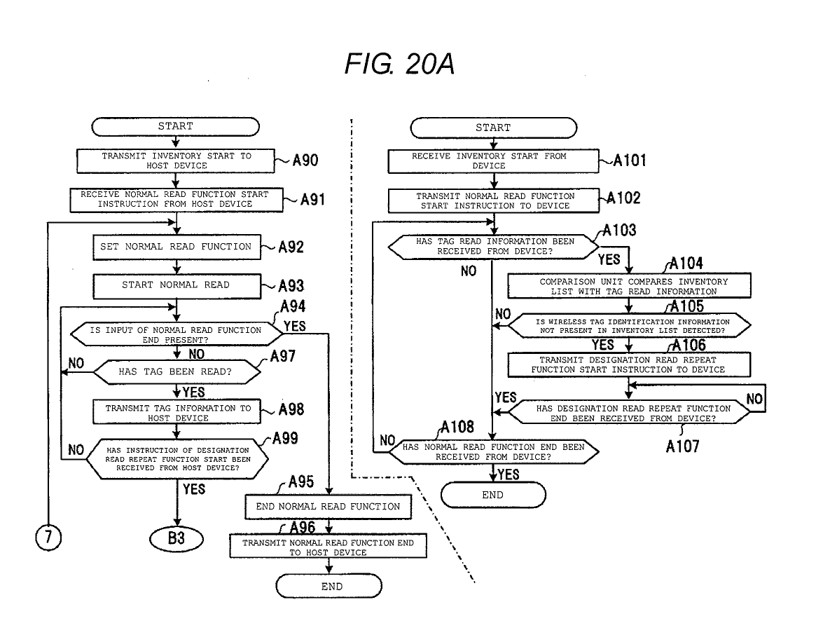

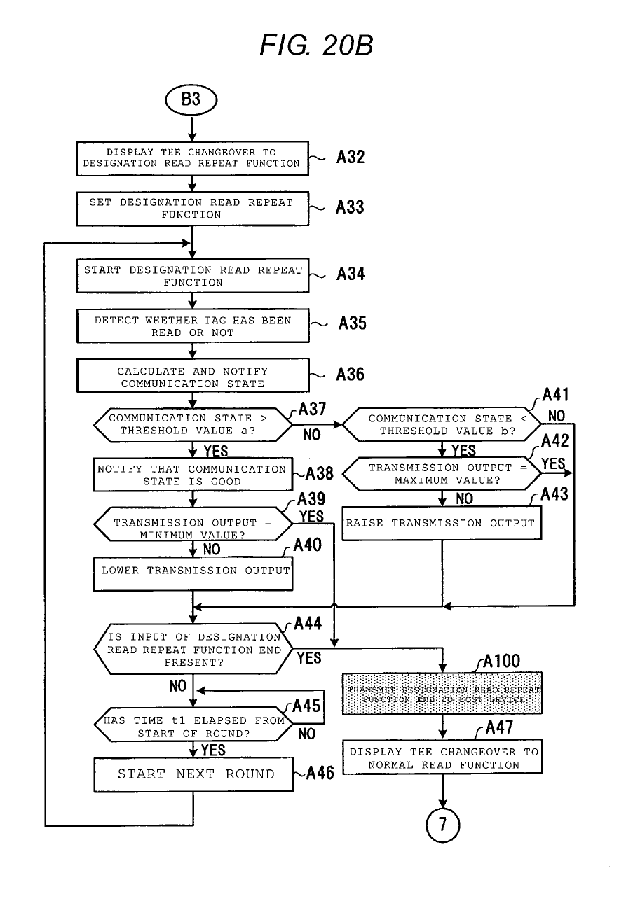

Next, a wireless tag communication system of a fifth embodiment will be described using FIGS. 20A and 20B. FIGS. 20A and 20B are flowcharts illustrating a processing procedure of the communication device 20 and the host device 100 in the fifth embodiment, the left parts of FIGS. 20A and 20B illustrate the processing procedure of the controller 34 of the communication device 20, and the right parts of FIG. 20A illustrate the processing procedure of the host device 100. In addition, the block diagram of the wireless tag communication system of the fifth embodiment is as shown in FIG. 18.

If it is detected that, for example, an inventory start key of the input unit 25 is operated by the operator, the controller 34 transmits “inventory start” to the host device 100 through the communication unit 331 (Act A90). If the host device 100 receives “inventory start” through the communication unit 332 (Act A101), the host device 100 transmits the instruction of “the start of the read operation by the normal read function” to the communication device 20 through the communication unit 332 (Act A102). Further, the communication device 20 may transmit the transmission output and the like at the time of performing the read operation by the normal read function, and may include an instruction using the transmission output in a case of performing the read operation by the normal read function stored in advance in the storage unit 75 of the communication device 20.

If the controller 34 receives the instruction of “the read operation start by the normal read function” from the host device 100 (Act A91), the controller 34 sets the normal read function in the function setting unit 73 of the communication controller 36 (Act A92). In other words, a transmission output setting signal corresponding to the transmission output that is set in advance in the case of the normal read function is output from the transmission output setting unit 71. Further, the transmission signal of the normal read function is output from the transmission controller 72, and the transmission controller 72 sets a timing of transmission, and the like.

Next, normal reading is started (Act A93). If the transmission output setting signal is output from the transmission output setting unit 71, an unmodulated carrier signal is radiated as a radio wave from the antenna 22, whereas if the transmission signal is output from the transmission controller 36, a transmission is performed with respect to the wireless tag 15.

For example, when it is detected whether there is the key input of the normal read function end from the input unit 25 (Act A94) and an input is detected, the controller 34 ends the read operation by the normal read function (Act A95), and transmits “end of the read operation by the normal read function” to the host device 100 (Act A96).

Further, when it is detected that there is no key input of the normal read function end, it is determined whether the tag identification information has been read in the normal read function (Act A97). Besides, when the tag identification information has been read, the read tag identification information is stored in the read order in the storage unit and tag identification information that is read is transmitted to the host device 100 through the communication unit 331 (Act A98). When the tag identification information has not been read in Act A97, the process returns to Act A94.

If the host device 100 receives the tag identification information that has been read from the communication device 20 (Act A103), the tag identification information is stored as the tag read information in the storage unit 35 in order of receipt. In addition, the host device 100 does not repeatedly store the same tag identification information as the tag identification information 351 that is stored in the tag read information of the storage unit 35. Further, the comparison unit 37 compares the tag read information 351 with the inventory list 352.

When the received tag read information 351 is not present in the inventory list 352, “0” is stored in the comparison result 2 of the wireless tag identification information of the tag read information 351. When the received tag read information 351 is present in the inventory list 352, “1” is stored in the comparison result 2 of wireless tag identification information corresponding to the tag read information 351, and the comparison result 1 of wireless tag identification information corresponding to the inventory list 352 is changed to “1” (Act A104).

Further, when the received tag read information 351 is not present in the inventory list 352 (Act A105), the host device 100 transmits an instruction of “designation read repeat function start” including the tag identification information not present in the inventory list 352 to the communication device 20 (Act A106).

If the controller 34 transmits the read tag identification information to the host device 100 (Act A98), it is detected whether an instruction of “designation read repeat function start” has been received from the host device 100 (Act A99). When “designation read repeat function start” is not detected, the process returns to Act A94. When “designation read repeat function start” is detected, the read operation by the normal read function is interrupted. Then, the process changes over to the read operation by the designation read repeat function, and thus the read operation by the designation read repeat function is performed.

In other words, the operation from Act A32 to Act A47 of FIG. 20B is performed. The operation of FIG. 20B is the same as the operation of FIG. 16, and Act A100 is added thereto. If simply described, when the communication state is good (Act A38), and the transmission output is a minimum value (Act A39), or when the input of the designation read repeat function end is detected (Act A44), and the controller 34 transmits “designation read repeat function end” to the host device 100 (Act A100). Further, changeover to the normal read function is displayed on the display 24 (Act A47), and the process returns to Act A92 of FIG. 20A. Then, the process changes over to the normal read function, and thus the normal read function is resumed.

If the host device 100 receives “designation read repeat function end” from the communication device 20 (Act A107 of FIG. 20A), it is detected whether “read operation end of the normal read function” is received from the communication device 20 (Act A108). Then, when “read operation end of the normal read function” is not detected, the process returns to Act A103. When “read operation end of the normal read function” is detected, the process is ended.

Similar to the third embodiment, by the read operation by the designation read repeat function, it is possible for the operator to easily narrow the possible location range of the object wireless tag to the read range of the transmission output minimum value that is set. During the read operation by the normal read function, if it is detected that the wireless tag not present in the inventory list 352 has been read, the normal read function is once interrupted, and the wireless tag can be simply specified and the normal read function after the specification can be resumed.

Therefore, after the read operation by the normal read function is performed throughout all areas of a store, it is not necessary for the operator to move in order to specify the read wireless tag not present in the inventory list 352, and thereby it is possible to shorten the time required for the inventory work, and to efficiently perform the inventory work.

Further, in the fifth embodiment, a case is described in which the reading by the designation read function is performed with respect to the list of the wireless tags when the wireless tag present in the inventory list has not been read, that is, the unread list, but the fifth embodiment may be applied to a case of performing a reading by the designation read repeat function with respect to a list of wireless tags in a case of reading wireless tags not present in the inventory list, that is, a search list.

As described above, in each embodiment, it is possible to provide a device and a system which can improve the read rate of the wireless tags in the inventory work, and can efficiently perform the inventory work in a short time. Further, it is possible to reduce a burden on the operator performing inventory work.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless tag communication device which communicates with wireless tags that are attached to a plurality of goods and stores at least identification information, and reads information stored in the wireless tags, and a device capable of communicating with the wireless tag communication device, the wireless tag communication device comprising:
a wireless tag communication unit which communicates with the wireless tags by a first read function that does not designate the wireless tags and a second read function that designates the wireless tags;
a controller that controls the wireless tag communication unit;
a storage unit that stores information regarding the wireless tags to be read;
a comparison unit which compares information concerning the wireless tags stored in the storage unit with information concerning wireless tags that may be read in the wireless tag communication unit, and outputs a read result; and
a route information setting unit that establishes a correlation of wireless tags that are expected to be read in comparison to the wireless tags that actually are read.

2. The wireless tag communication device of claim 1, further comprising:
an unread list generation unit configured to generate an unread list, based upon the correlation of wireless tags that are expected to be read in comparison to the wireless tags that actually are read.

3. The wireless tag communication device of claim 2, wherein the unread list generation unit is further configures to generate information concerning the location of unread tags along the route.

4. The wireless tag communication device according to claim 1, further comprising:
a notification unit that notifies read states of the wireless tags read by the wireless tag communication unit,
such that, if the comparison unit has read wireless tags not present in the list of the read objects during a read operation by the first read function, the controller controls the wireless tag communication unit to change the read operation by the first read function to a read operation by the second read function in order to repeat the read operation by the second read function, notifies the changeover of the read operation by the notification unit, and repeatedly performs the read operation by the second read function.

5. The wireless tag communication device of claim 4, further including a signal energy changing system and a weighing system, wherein, if a wireless tag which is not expected is detected, the signal energy may be changed to enable localized detection of the wireless tag in the inventory.

6. The wireless tag inventory device of claim 5, wherein the weighing system determines the number of times a wireless tag responds to a query in a set number of queries, and modifies the signal energy in response to that result.

7. The wireless tag inventory device of claim 1, further including a tag writer, wherein information concerning the article to which the tag is attached may be modified in an inventory list.

8. A wireless tag communication system which includes a wireless tag communication device which communicates with wireless tags that are attached to a plurality of goods and stores at least identification information, and reads information stored in the wireless tags, and a device capable of communicating with the wireless tag communication device,
the wireless tag communication device comprising:
a wireless tag communication unit which communicates with the wireless tags by a first read function that does not designate the wireless tags and a second read function that designates the wireless tags;
a controller that controls the wireless tag communication unit; and
a route information input unit that sets designation order values of wireless tags present in the read objects but not being read by the first read function, when the wireless tags are designated and read by the second read function, and
the device comprising:
a storage unit that stores information concerning the wireless tags expected to be read;
a comparison unit which compares information regarding the identity of the wireless tags stored in the storage unit with read information of the wireless tags that have been read in the wireless tag communication unit, and outputs a read result; and
an unread list generation unit that generates an unread list, on a basis of information of the designated wireless tags, a result read by the second read function, and information of the designation order values that are set in the route information setting unit.

9. The wireless tag communication system of claim 8, wherein the comparison unit further outputs the result of wireless tags read that are not expected to be read.

10. The wireless communication system of claim 8, wherein the designation order values include information concerning the location of tags along a route.

11. The wireless tag communication system of claim 10, wherein the information concerning the location of tags along a route includes information concerning tags read that are not expected to be read.

12. The wireless tag communication system of claim 8, further including a tag writing system capable of changing information concerning the correspondence between the tag and an item to which the tag is associated.

13. A wireless tag communication system which includes a wireless tag communication device which communicates with wireless tags that are attached to a plurality of goods and stores at least identification information, and reads information stored in the wireless tags, and a device capable of communicating with the wireless tag communication device,
the wireless tag communication device comprising:
a wireless tag communication unit which communicates with the wireless tags by a first read function that does not designate the wireless tags and a third read function that designates the wireless tags, sets a transmission output according to read states of the designated wireless tags and repeatedly perform a read operation;
a controller that controls the wireless tag communication unit;
a route information setting unit that, when wireless tags not being read objects have been read, if the wireless tags are read by the third read function, sets designation order values of the wireless tags; and
a notification unit that notifies read states of the wireless tags, and
the device comprising:
a storage unit that stores information of wireless tags being the read objects;
a comparison unit which compares information of the wireless tags stored in the storage unit with read information of the wireless tags that have been read in the wireless tag communication unit, and outputs a read result; and
a search list generation unit that generates a search list, on a basis of a result read by the third read function, and information of the designation order values that are set in the route information setting unit.

14. The wireless tag communication system of claim 13, wherein the search list included data concerning the location of a tag on the search list.

15. The wireless tag communication device of claim 13, wherein the third read function selectively changes the signal power of the wireless signal in comparison to a threshold value of a number of times a specific wireless tags returns a signal.

16. A program stored in a non-transitory computer readable medium which communicates with wireless tags storing at least identification information, and reads and processes information stored in the wireless tags, the program causing a computer to realize:
a control function that controls a wireless tag communication unit, and communicates with the wireless tags by a first read function that does not designate the wireless tags and a second read function that designates the wireless tags;
a comparison function that compares information concerning the identities of wireless tags stored in a storage unit with read information of the wireless tags that have been read in the wireless tag communication unit, and outputs a read result;
a setting function that sets designation order values of wireless tags present in a list of the read objects but not read by the first read function, when the wireless tags are designated and read by the second read function; and
an unread list generation function that generates an unread list, on a basis of information of the designated wireless tags, a result read by the second read function, and information of the designation order values that are set.

17. The program according to claim 16, further including:
a transition function that, when it is determined that a wireless tag not present in a list of the read objects have been read during a read operation by the first read function, controls the wireless tag communication unit to change the read operation by the first read function to the read operation by the second read function in order to repeat the read operation by the second read function; and
an execution function that initiates the changeover of the read operation by the notification unit, and repeatedly performs the read operation by the second read function.

18. The program according to claim 17, wherein the second read function terminates when the wireless tag not present in a list of the read objects is located.

19. The program according to claim 18, wherein the first read function resumes when the second read function is terminated.

20. The program according to claim 19, wherein, upon determining that another wireless tag not present in the list of read objects is present, the execution function initiates the changeover of the read operation by the notification unit, and repeatedly performs the read operation by the second read function until the additional wireless tag not present in the list of read objects is located.
